(19) United States
(12) Patent Application Publication
(10) Pub. No.: US 2023/0350640 A1
(43) Pub. Date: Nov. 2, 2023

(54) SYSTEM AND METHOD OF ROTATING VECTOR INPUT

(71) Applicant: QUALCOMM Incorporated, San Diego, CA (US)

(72) Inventors: Sundar Rajan BALASUBRAMANIAN, GROTON, MA (US); Srijesh SUDARSANAN, Waltham, MA (US); Marc HOFFMAN, Mansfield, MA (US); Deepak MATHEW, Acton, MA (US); Gerald SWEENEY, Chelmsford, MA (US); James LEE, Northborough, MA (US); Mansi JAIN, Littleton, MA (US)

(21) Appl. No.: 17/661,707

(22) Filed: May 2, 2022

(51) Int. Cl. G06F 7/544; G06F 17/16

(52) U.S. Cl. CPC G06F 7/5443; G06F 17/16

(57) ABSTRACT

A device includes a processor that includes a rotation vector register file, a second vector register file, and multiply-accumulate circuitry (MAC). The rotation vector register file includes a rotation vector register. The rotation vector register file is configured to rotate data in the rotation vector register. The second vector register file includes a source vector register. The MAC is configured to receive first input data from the rotation vector register file and second input data from the source vector register.

### I. FIELD

The present disclosure is generally related to data in a vector register for vector processing.

### II. DESCRIPTION OF RELATED ART

Advances in technology have resulted in smaller and more powerful computing devices. For example, there currently exist a variety of portable personal computing devices, including wireless telephones such as mobile and smart phones, tablets and laptop computers that are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process executable instructions, including software applications, such as a web browser application, that can be used to access the Internet. As such, these devices can include significant computing capabilities.

A computing device may include one or more digital signal processors (DSPs), network processing units (NPUs), network signal processors (NSPs), image processors, or other processing devices that perform vector processing that includes performing multiple instances of a common operation (e.g., a multiply operation) to process multiple elements of vector data in parallel. For example, a vector may include multiple sub-vector values, such as 16 sub-vector values that each includes 4 half-word values. In an illustrative multiply operation, for each sub-vector value of the vector, the first half-word is multiplied by a first one-byte value, the second half-word is multiplied by a second one-byte value, the third half-word is multiplied by a third one-byte value, and the fourth half-word is multiplied by a fourth one-byte value. The four multiplication products are added together, and the resulting sum is added to an accumulate vector register.

In some examples, each sub-vector value (e.g., 4 half-word values) can be read from a scalar register and provided as an input to multiplication circuitry. However, data transfer of the half-word values from memory (e.g., dynamic random-access memory (DRAM), static random-access memory (SRAM), or another type of memory) into a scalar register can cause a processing bottleneck due to the scalar register being loaded via conventional processor operations that involve multiple transfers of the data (e.g., loading the sub-vector value from memory to a second-level (L2) cache, from the L2 cache to a first-level (L1) cache, and from the L1 cache to a scalar register in a register file).

### III. SUMMARY

According to one implementation of the present disclosure, a device includes a processor that includes a rotation vector register file, a second vector register file, and multiply-accumulate circuitry (MAC). The rotation vector register file includes a rotation vector register. The rotation vector register file is configured to rotate data in the rotation vector register. The second vector register file includes a source vector register. The MAC is configured to receive first input data from the rotation vector register file and second input data from the source vector register.

According to another implementation of the present disclosure, a processor-implemented method includes rotating, using a rotation vector register file, data in a rotation vector register of the rotation vector register file. The processor-implemented method also includes receiving, at multiply-accumulate circuitry (MAC), first input data from the rotation vector register file. The processor-implemented method further includes receiving, at the MAC, second input data from a source vector register of a second vector register file.

According to another implementation of the present disclosure, a non-transitory computer-readable medium includes instructions that, when executed by a processor, cause the processor to rotate, using a rotation vector register file, data in a rotation vector register of the rotation vector register file. The instructions, when executed by the processor also cause the processor to receive, at multiply-accumulate circuitry (MAC), first input data from the rotation vector register file. The instructions, when executed by the processor further cause the processor to receive, at the MAC, second input data from a source vector register of a second vector register file.

According to another implementation of the present disclosure, an apparatus includes means for rotating data in a rotation vector register of a rotation vector register file. The apparatus also includes means for receiving first input data at multiply-accumulate circuitry (MAC) from the rotation vector register file. The apparatus further includes means for receiving second input data at the MAC from a source vector register of a second vector register file.

Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1A is a block diagram of a particular illustrative aspect of a system operable to rotate vector input, in accordance with some examples of the present disclosure.

FIG. 1B is a diagram of an illustrative aspect of rotation of data of a rotation vector register of the system of FIG. 1A, in accordance with some examples of the present disclosure.

FIG. 2A is a diagram of an illustrative aspect of components of the system of FIG. 1A operable to rotate vector input for executing an instruction, in accordance with some examples of the present disclosure.

FIG. 2B is a diagram of an illustrative aspect of a change in performance (e.g., count of operations) versus a change in operational intensity (e.g., operations per byte) of the system of FIG. 1A, in accordance with some examples of the present disclosure.

FIG. 3 is a diagram of an illustrative aspect of a first state of vector registers of the system of FIG. 1A prior to a first processing stage of execution of the instruction of FIG. 2A, in accordance with some examples of the present disclosure.

FIG. 4 is a diagram of an illustrative aspect of operation of components of the system of FIG. 1A during a first sub-stage of the first processing stage of execution of the instruction of FIG. 2A, in accordance with some examples of the present disclosure.

FIG. 5 is a diagram of an illustrative aspect of a second state of vector registers of the system of FIG. 1A subsequent to the first sub-stage of the first processing stage of execution of the instruction of FIG. 2A, in accordance with some examples of the present disclosure.

FIG. 6 is a diagram of an illustrative aspect of operation of components of the system of FIG. 1A during a second sub-stage of the first processing stage of execution of the instruction of FIG. 2A, in accordance with some examples of the present disclosure.

FIG. 7 is a diagram of an illustrative aspect of a third state of vector registers of the system of FIG. 1A subsequent to the first processing stage of execution of the instruction of FIG. 2A, in accordance with some examples of the present disclosure.

FIG. 8 is a diagram of an illustrative aspect of rotation of data of a rotation vector register of the system of FIG. 1A during execution of the instruction of FIG. 2A, in accordance with some examples of the present disclosure.

FIG. 9 is a diagram of an illustrative aspect of a fourth state of vector registers of the system of FIG. 1A prior to a second processing stage of execution of the instruction of FIG. 2A, in accordance with some examples of the present disclosure.

FIG. 10 is a diagram of an illustrative aspect of operation of components of the system of FIG. 1A during a first sub-stage of the second processing stage of execution of the instruction of FIG. 2A, in accordance with some examples of the present disclosure.

FIG. 11 is a diagram of an illustrative aspect of a fifth state of vector registers of the system of FIG. 1A subsequent to the first sub-stage of the second processing stage of execution of the instruction of FIG. 2A, in accordance with some examples of the present disclosure.

FIG. 12 is a diagram of an illustrative aspect of operation of selection circuitry of the system of FIG. 1A, in accordance with some examples of the present disclosure.

FIG. 13 is a diagram of an illustrative aspect of operation of rotation circuitry of the system of FIG. 1A, in accordance with some examples of the present disclosure.

FIG. 14 illustrates an example of an integrated circuit that includes a rotation vector register file operable to rotate vector input, in accordance with some examples of the present disclosure.

FIG. 15 is a diagram of a mobile device that includes a rotation vector register file operable to rotate vector input, in accordance with some examples of the present disclosure.

FIG. 16 is a diagram of a headset that includes a rotation vector register file operable to rotate vector input, in accordance with some examples of the present disclosure.

FIG. 17 is a diagram of a wearable electronic device that includes a rotation vector register file operable to rotate vector input, in accordance with some examples of the present disclosure.

FIG. 18 is a diagram of a voice-controlled speaker system that includes a rotation vector register file operable to rotate vector input, in accordance with some examples of the present disclosure.

FIG. 19 is a diagram of a camera that includes a rotation vector register file operable to rotate vector input, in accordance with some examples of the present disclosure.

FIG. 20 is a diagram of a headset, such as a virtual reality, mixed reality, or augmented reality headset, that includes a rotation vector register file operable to rotate vector input, in accordance with some examples of the present disclosure.

FIG. 21 is a diagram of a first example of a vehicle that includes a rotation vector register file operable to rotate vector input, in accordance with some examples of the present disclosure.

FIG. 22 is a diagram of a second example of a vehicle that includes a rotation vector register file operable to rotate vector input, in accordance with some examples of the present disclosure.

FIG. 23 is diagram of a particular implementation of a method of rotating vector input that may be performed by the device of FIG. 1A, in accordance with some examples of the present disclosure.

FIG. 24 is a block diagram of a particular illustrative example of a device that that includes a rotation vector register file operable to rotate vector input, in accordance with some examples of the present disclosure.

### V. DETAILED DESCRIPTION

A vector register file is disclosed that includes a rotation vector register and rotation circuitry. The rotation circuitry is operable to rotate vector data in the rotation vector register prior to providing sub-vector values of the rotated vector data as input to another circuit, such as a multiply-accumulate circuitry (MAC). In conventional systems, multiple transfers of data to load sub-vector values from memory into a scalar register cause processing bottlenecks. Such processing bottlenecks are reduced (e.g., eliminated) by using the vector register file instead of the scalar register because the sub-vector values can be loaded into the rotation vector register with fewer transfers (e.g., a single transfer) of data.

According to some aspects, a vector load operation can be performed to load vector data to the rotation vector register. In some examples, the vector data is loaded from memory to a cache memory (e.g., a L2 cache) and from the cache memory to the rotation vector register. Any intermediate cache memory (e.g., a L1 cache) between the cache memory (e.g., the L2 cache) and the rotation vector register is bypassed to reduce an overhead associated with loading data from the cache memory (e.g., the L2 cache) to the intermediate cache memory (e.g., the L1 cache) and from the intermediate cache memory to the rotation vector register. The vector data may include multiple sub-vector values (e.g., 16 sub-vector values). Each sub-vector value may include multiple elements (e.g., 4 half-words).

Artificial neural network processing for machine learning tasks is often computationally intensive, requiring vast numbers of multiply and add operations. In some examples, a processor can execute a vector instruction (e.g., a multiply-accumulate instruction) to multiply each element of each sub-vector value stored in the rotation vector register with elements of vector data stored in a source vector register. For example, during a first processing stage of executing the vector instruction, the processor broadcasts elements (e.g., 4 half-words) of a sub-vector value (v0-v3) of the rotation vector register to respective multipliers. To illustrate, a first half-word (v0), a second half-word (v1), a third half-word (v2), and a fourth half-word (v3) of a sub-vector value are broadcast in parallel to a first multiplier, a second multiplier, a third multiplier, and a fourth multiplier, respectively.

The source vector register stores a sub-vector value (s0-s3) that includes a first one-byte value (s0), a second one-byte value (s1), a third one-byte value (s2), and a fourth one-byte value (s3). As used herein, ‘v’ is used as a prefix to denote sub-vector values read from the rotation vector register, and ‘s’ is used as a prefix to denote sub-vector values that are read from the source vector register.

During a first sub-stage of the first processing stage, each element of the sub-vector value of the rotation vector register is multiplied by a corresponding value of the sub-vector value of the source vector register. For example, the first multiplier generates a first multiplication product (v0s0) by multiplying the first half-word (v0) with the first one-byte value (s0), a second multiplication product (v1s1) by multiplying the second half-word (v1) with the second one-byte value (s1), a third multiplication product (v2s2) by multiplying the third half-word (v2) with the third one-byte value (s2), and a fourth multiplication product (v3s3) by multiplying the fourth half-word (v3) with the fourth one-byte value (s3). The four multiplication products are added together, and the resulting sum is added to an accumulate vector register.

During a second sub-stage of the first processing stage, each element of the sub-vector value (v0-v3) of the rotation vector register is multiplied by a corresponding value of a next sub-vector value (s4-s7) of the source vector register. The four multiplication products are added together, and the resulting sum is added to the accumulate vector register. In some aspects, additional sub-stages of the first processing stage are performed until the sub-vector value (v0-v3) of the rotation vector register has been multiplied with all the sub-vector values of the source vector register.

Subsequent to the first processing stage, a next sub-vector value (v4-v7) of the rotation vector register is to be used for multiplication. Conventionally, enabling broadcasting of elements of sub-vector values from different portions of a vector register can increase circuit complexity. For example, selection circuitry has to be able to read each element (e.g., each of the 4 half-word values) of each of the sub-vector values of the rotation vector register to provide a selected sub-vector value as input to the broadcast circuitry for broadcast to appropriate multipliers.

To reduce such complexity, rotation circuitry is used to rotate data in the rotation vector register. For example, a particular portion of the rotation vector register is dedicated for broadcasting. During the first processing stage, the sub-vector value (v0-v3) is read from the dedicated portion of the rotation vector register and broadcast to the multipliers. During a rotation stage subsequent to the first processing stage, the sub-vector values are rotated in the rotation vector register such that the next sub-vector value (v4-v7) is moved to the dedicated portion of the rotation vector register. During a second processing stage subsequent to the rotation stage, the next sub-vector value (v4-v7) is broadcast to the multipliers, and the multipliers generate multiplication products based on the next sub-vector value and update the accumulate vector register.

In some aspects, additional rotation stages and processing stages may be performed until all sub-vector values of the rotation vector register have been rotated to the dedicated portion at least once, and then a next batch of vector data may be loaded to the rotation vector register. Enabling selection circuitry to read data from elements of the dedicated portion of the rotation vector register reduces circuit complexity as compared to enabling the selection circuitry to read data from all portions of the rotation vector register.

A sub-vector value of the rotation vector register including four elements (e.g., 4 half-word values) that are broadcast to four multipliers is provided as an illustrative example. In other examples, a sub-vector value of the rotation vector register may include fewer than four or more than four elements that are broadcast to respective multipliers.

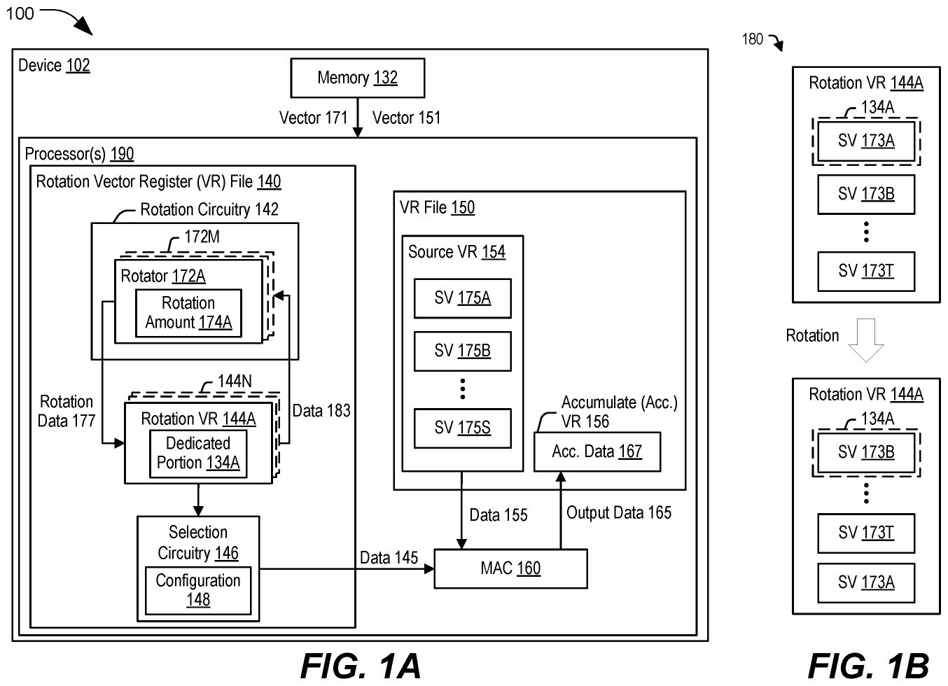

Particular aspects of the present disclosure are described below with reference to the drawings. In the description, common features are designated by common reference numbers. As used herein, various terminology is used for the purpose of describing particular implementations only and is not intended to be limiting of implementations. For example, the singular forms “a,” “an,” and “the” are intended to include the plural forms as well, unless the context clearly indicates otherwise. Further, some features described herein are singular in some implementations and plural in other implementations. To illustrate, FIG. 1A depicts a device 102 including one or more processors (“processor(s)” 190 of FIG. 1A), which indicates that in some implementations the device 102 includes a single processor 190 and in other implementations the device 102 includes multiple processors 190. For ease of reference herein, such features are generally introduced as “one or more” features and are subsequently referred to in the singular unless aspects related to multiple of the features are being described.

In some drawings, multiple instances of a particular type of feature are used. Although these features are physically and/or logically distinct, the same reference number is used for each, and the different instances are distinguished by addition of a letter to the reference number. For example, referring to FIG. 1A, one or more rotators are illustrated and associated with reference numbers 172A and 172M. When referring to a particular one of these rotators, such as a rotator 172A, the distinguishing letter “A” is used. However, when referring to any arbitrary one of these rotators, the reference number 172 is used without a distinguishing letter.

As used herein, the terms “comprise,” “comprises,” and “comprising” may be used interchangeably with “include,” “includes,” or “including.” Additionally, the term “wherein” may be used interchangeably with “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive signals (e.g., digital signals or analog signals) directly or indirectly, via one or more wires, buses, networks, etc. As used herein, “directly coupled” may include two devices that are coupled (e.g., communicatively coupled, electrically coupled, or physically coupled) without intervening components.

In the present disclosure, terms such as “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “generating,” “calculating,” “estimating,” “using,” “selecting,” “accessing,” and “determining” may be used interchangeably. For example, “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

Referring to FIG. 1A, a particular illustrative aspect of a system 100 configured to rotate vector input is shown. The system 100 includes a device 102 that includes a memory 132 coupled to one or more processors 190.

The one or more processors 190 include multiply-accumulate circuitry (MAC) 160 coupled to a vector register (VR) file 150 and a rotation VR file 140. The VR file 150 includes a source VR 154, an accumulate VR 156, one or more additional VRs, or a combination thereof. The rotation VR file 140 includes one or more rotation VRs 144 coupled to rotation circuitry 142. The one or more rotation VRs 144 include a rotation VR 144A, one or more additional rotation VRs, a rotation VR 144N, or a combination thereof, and are referred to herein as rotation VRs 144A-144N. In some examples, the rotation VRs 144A-144N include a single rotation VR 144A. In other examples, the rotation VRs 144A-144N include the rotation VR 144A and one or more additional rotation VRs.

The rotation circuitry 142 includes one or more rotators, such as a rotator 172A, one or more additional rotators, a rotator 172M, or a combination thereof, and are referred to herein as rotators 172A-172M. In some examples, the rotators 172A-172M include a single rotator 172A. In other examples, the rotators 172A-172M include the rotator 172A and one or more additional rotators. A count of the rotators 172A-172M can be less than, equal to, or greater than a count of the rotation VRs 144A-144N.

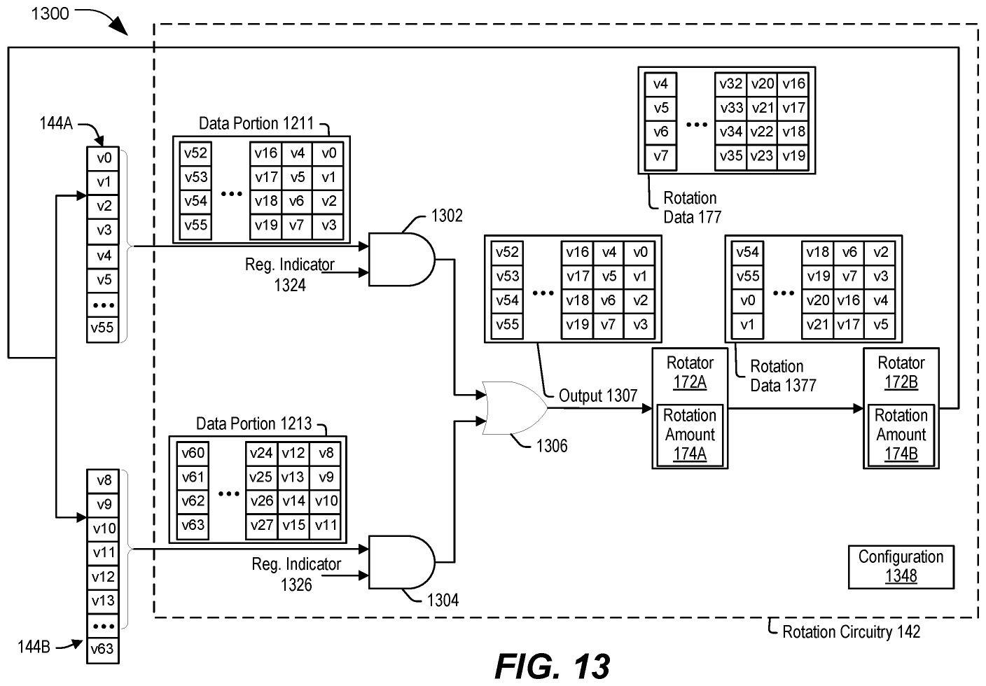

Each of the rotators 172A-172M is configured to rotate data by a rotation amount. For example, the rotator 172A is configured to receive data 183 from one or more of the rotation VRs 144A-144N, perform a data rotation corresponding to a rotation amount 174A to generate rotation data 177, and to store the rotation data 177 in the one or more of the rotation VRs 144A-144N, as further described with reference to FIG. 13. To illustrate, performing the data rotation includes rotating at least a portion of the data 183 by the rotation amount 174A.

In some implementations, the rotation VR 144A and the rotator 172A together function as a shift register. For example, the rotator 172A can include multiplexors, dedicated wiring, or other bit shifting hardware to cause bit values read from the rotation VR 144A to be written back into the rotation VR 144A at shifted positions corresponding to the rotation amount 174A. To illustrate, the rotator 172A performs a circular shift of the bit values read from the rotation VR 144A based on the rotation amount 174A.

In some alternative implementations, the rotation VRs 144A-144N include shift registers and the rotators 172A-172M provide inputs (e.g., data advance signals) based on the rotation amounts to the rotation VRs 144A-144N to perform data rotations. As an illustrative example, the rotation VR 144A includes a shift register with a cascade of flip-flops where the output of one flip-flop is connected to the input of a next flip-flop and a last flip-flop is connected to a first flip-flop. Upon receiving a data advance signal, a bit value stored at each flip-flop is shifted to the next flip-flop with the bit value from the last flip-flop shifted to the first flip-flop. In some aspects, the rotator 172A provides data advance signals to the rotation VR 144A, where the count of data advance signals provided to the rotation VR 144A is based on the rotation amount 174A.

In some implementations, a variable target rotation can be accomplished with multiple cascaded fixed rotations, as further described with reference to FIG. 13. In an illustrative example, the rotator 172A reads bits values from the rotation VR 144A, generates first rotated bit values by rotating the bit values based on the rotation amount 174A, and stores the first rotated bit values in a pipeline register. A second rotator of the rotators 172A-172M reads the first rotated bit values from the pipeline register, generates second rotated bit values based on the first rotated bit values, and writes the second rotated bit values to the rotation VR 144A. In an example, the second rotator is configured to selectively rotate bit values based on a second rotation amount. To illustrate, if the target rotation is the same as the rotation amount 174A, the second rotator outputs the first rotated bit values (without rotation) as the second rotated bit values. If the target rotation is the same as a sum of the rotation amount 174A and a second rotation amount, the second rotator rotates the first rotated bit values based on the second rotation amount. Thus, a variable target rotation (e.g., the rotation amount 174A or a sum of the rotation amount 174A and the second rotation amount) can be accomplished using two cascaded rotations. The fixed rotation amounts to be cascaded can be selected at least partially based on an instruction set architecture (ISA) specification associated with the MAC 160 that may describe various rotation amounts to be supported. Using a pair of rotators that is each configured to perform a predetermined rotation can reduce hardware cost (e.g., power consumption, area, or both), improve performance (e.g., faster execution), or a combination thereof, as compared to a single rotator that is configured to perform variable rotations.

The rotation VRs 144A-144N are also coupled to selection circuitry 146. In some implementations, the selection circuitry 146 is configured to read data from a dedicated portion of each of the rotation VRs 144A-144N and is not configured to read data from remaining portions of each of the rotation VRs 144A-144N. As an illustrative example, the rotation VR 144A includes a dedicated portion 134A that is readable by the selection circuitry 146. In some implementations, the selection circuitry 146 is configured to read data from the dedicated portion 134A, and is not configured to read data from remaining portions of the rotation VR 144A. For example, in these implementations, the selection circuitry 146 is coupled to the dedicated portion 134A of the rotation VR 144A, and is not coupled to the remaining portions of the rotation VR 144A.

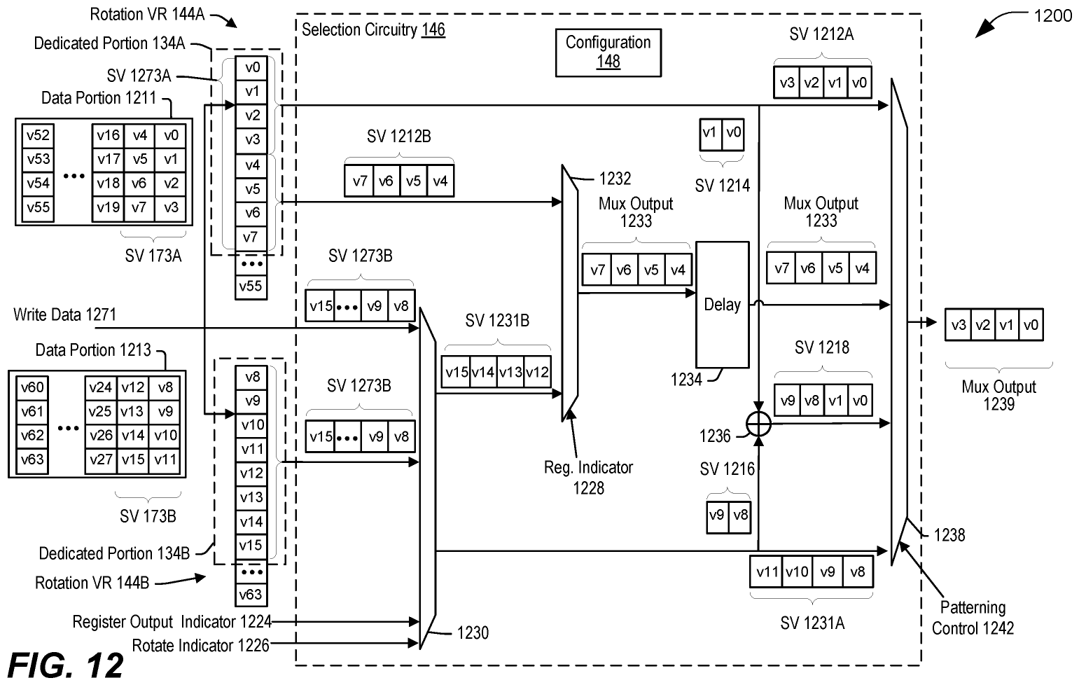

In some implementations, the selection circuitry 146 is configurable. For example, the selection circuitry 146 can, based on a configuration 148, read data 145 from one or more sub-portions of the dedicated portions of the rotation VRs 144A-144N, as further described with reference to FIG. 12.

The MAC 160 is configured to receive the data 145 from the rotation VR file 140, and to receive data 155 from the source VR 154. The MAC 160 is configured to generate output data 165 based on the data 145 and the data 155. For example, the MAC 160 is configured to generate a multiplication product based on an element of the data 145 and an element of the data 155, to generate the output data 165 based on the multiplication product, and to update accumulate data 167 of the accumulate VR 156 based on the output data 165. To illustrate, the MAC 160 can be used in conjunction with artificial neural network processing that includes multiplying weight values by corresponding activation values. In an artificial neural network example, the data 145 can correspond to the activation values and the data 155 can correspond to the weight values. In some examples, the MAC 160 is configured to store the output data 165 as the accumulate data 167 in the accumulate VR 156. In some examples, the MAC 160 is configured to update the accumulate data 167 by adding a value indicated by the output data 165 to a value indicated by the accumulate data 167, and storing the sum as the accumulate data 167 in the accumulate VR 156.

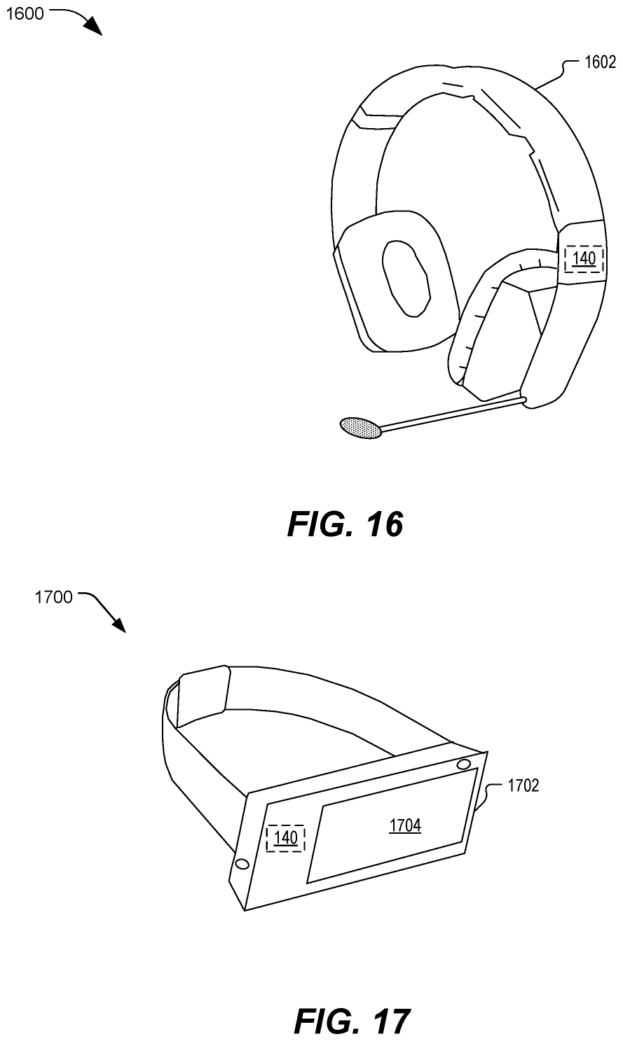

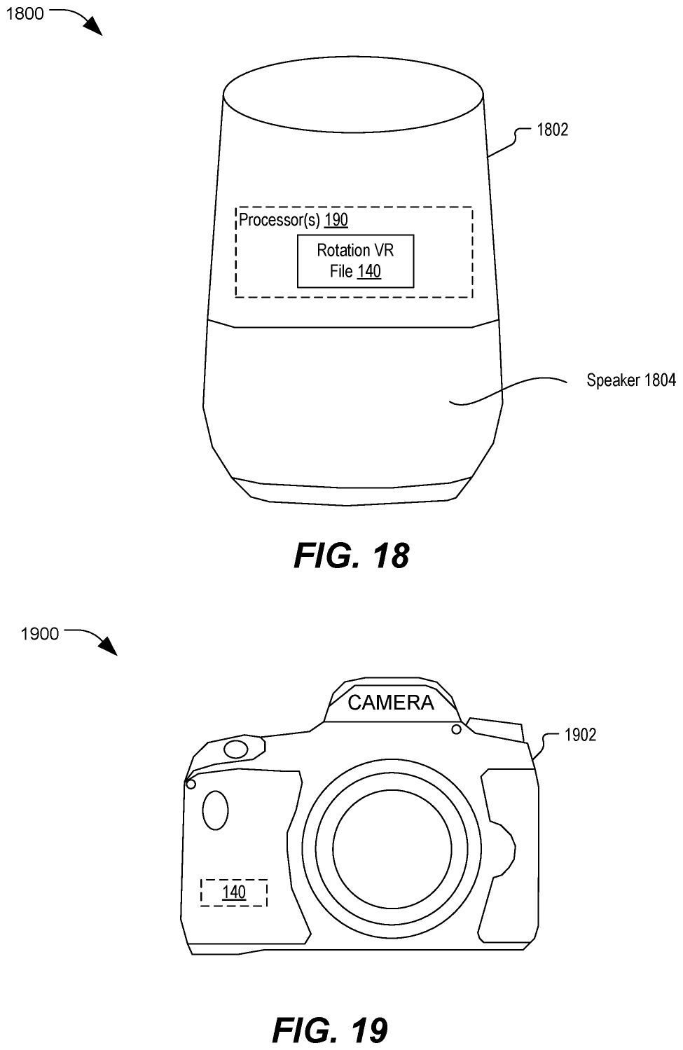

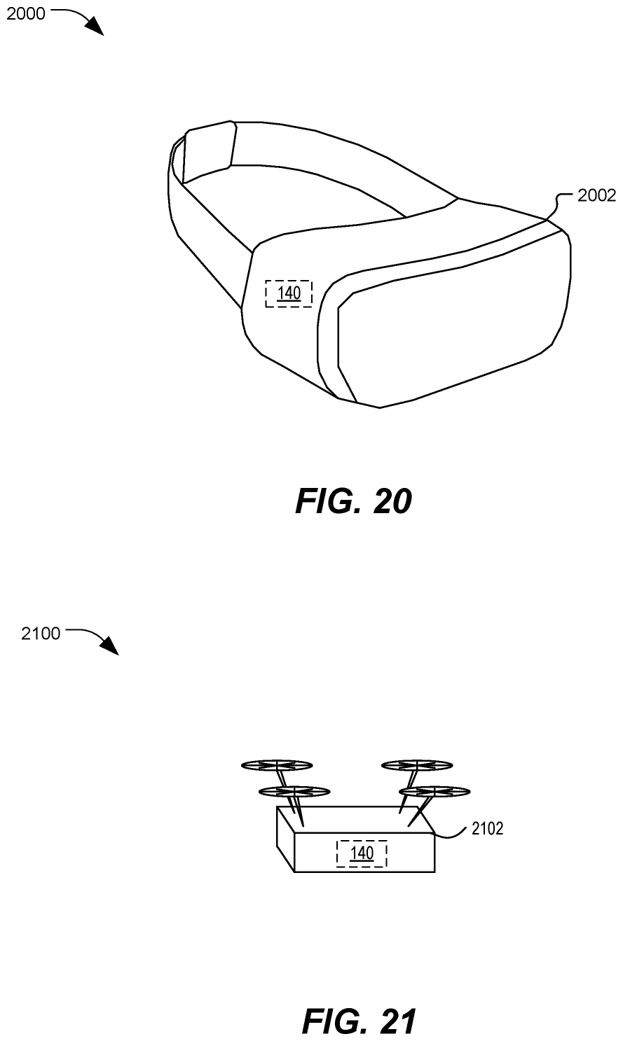

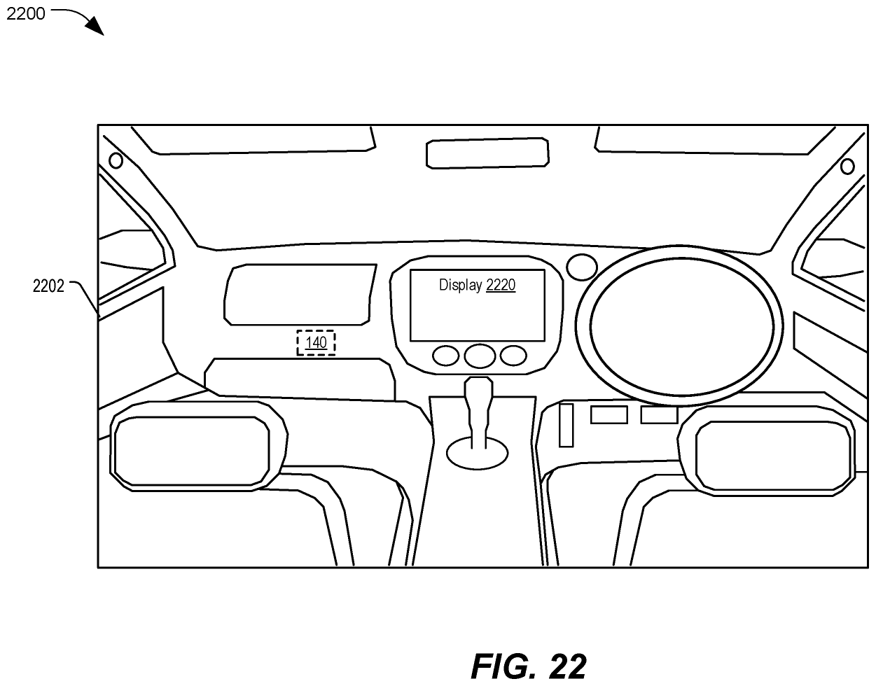

In some implementations, the device 102 corresponds to or is included in one of various types of devices. In an illustrative example, the one or more processors 190 are integrated in a headset device, such as described further with reference to FIG. 16. In other examples, the one or more processors 190 are integrated in at least one of a mobile phone or a tablet computer device, as described with reference to FIG. 15, a wearable electronic device, as described with reference to FIG. 17, a voice-controlled speaker system, as described with reference to FIG. 18, a camera device, as described with reference to FIG. 19, or a virtual reality, mixed reality, or augmented reality headset, as described with reference to FIG. 20. In another illustrative example, the one or more processors 190 are integrated into a vehicle, such as described further with reference to FIG. 21 and FIG. 22.

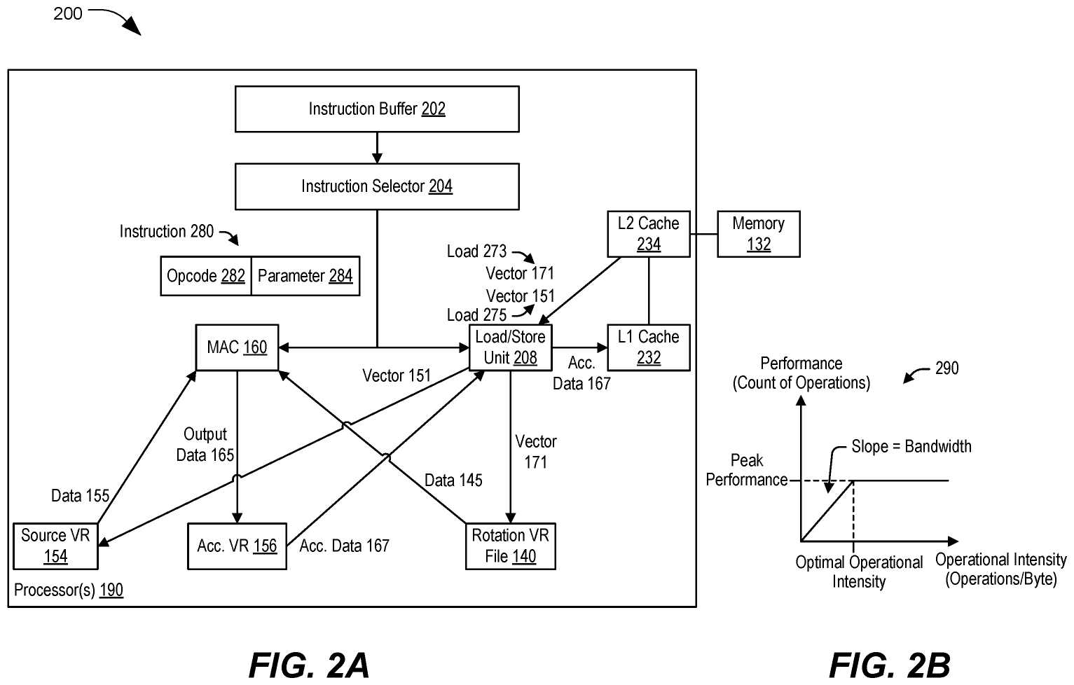

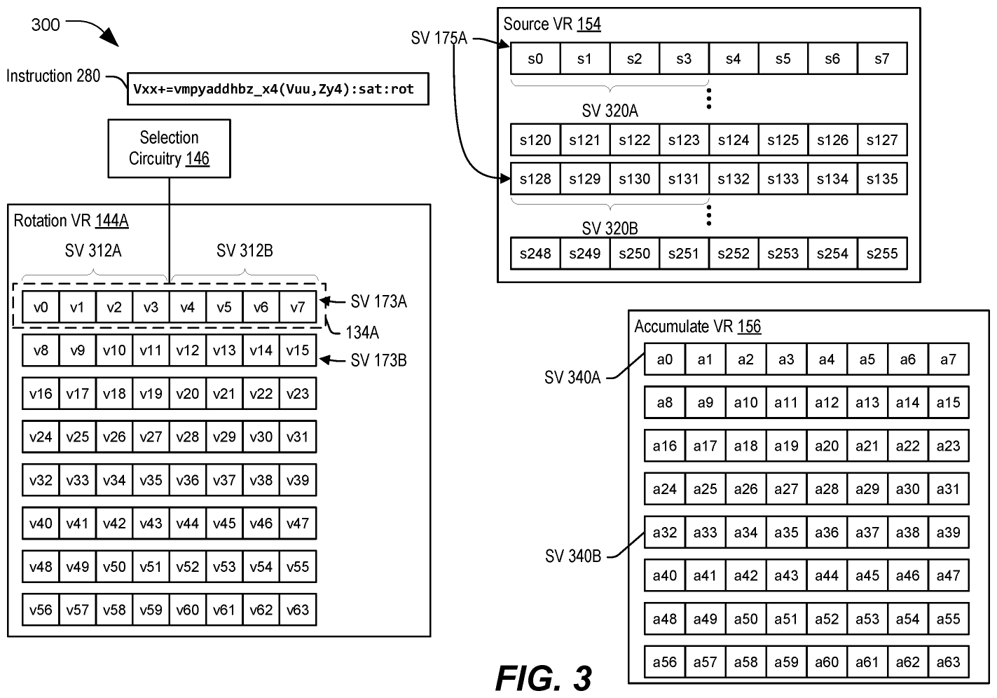

During operation, a vector 151 is loaded from the memory 132 to the source VR 154, and a vector 171 is loaded from the memory 132 to the rotation VRs 144A-144N, as further described with reference to FIG. 2A. In a particular aspect, the vector 171 includes a plurality of sub-vector values, such as a sub-vector value (SV) 173A, an SV 173B, one or more additional SVs, an SV 173T, or a combination thereof, and are referred to herein as SVs 173A-173T. The SV 173A-173T are illustrated in FIG. 1B as data stored in the rotation VR 144A that can be rotated, described further below. In a particular aspect, the vector 151 includes a plurality of sub-vector values, such as an SV 175A, an SV 175B, one or more additional SVs, an SV 175S, or a combination thereof, and are referred to herein as SVs 175A-173S. A count of the SVs 173A-173T can be less than, equal to, or greater than a count of the SVs 175A-175S. In some examples, the vector 151 is loaded into a single source vector register (e.g., the source VR 154) and the vector 171 is loaded into a single rotation VR (e.g., the rotation VR 144A), as further described with reference to FIG. 3. In some examples, the vector 171 is loaded into multiple rotation vector registers. For example, a portion of the vector 171 is loaded into the rotation VR 144A and another portion of the vector 171 is loaded into the rotation VR 144B, as further described with reference to FIGS. 12-13. In some examples, the vector 151 may be loaded into multiple source vector registers that include the source VR 154 and one or more additional source VRs.

Elements of the vector 171 from the rotation VRs 144A-144N are to be multiplied with elements of the vector 151 from the source VR 154 to generate an output that is to be stored in the accumulate VR 156. In an illustrative example, the vector 171 is stored in the rotation VR 144A, and the elements of the vector 171 stored in the rotation VR 144A are to be multiplied by the MAC 160 with the elements of the vector 151 stored in the source VR 154. For example, during each of multiple processing stages, a different SV stored in the rotation VR 144A is to be multiplied with SVs stored in the source VR 154.

In an illustrative example, during a first processing stage, the selection circuitry 146, based on the configuration 148, reads the SV 173A from the dedicated portion 134A of the rotation VR 144A, as further described with reference to FIG. 12. The selection circuitry 146 provides the SV 173A as the data 145 to the MAC 160.

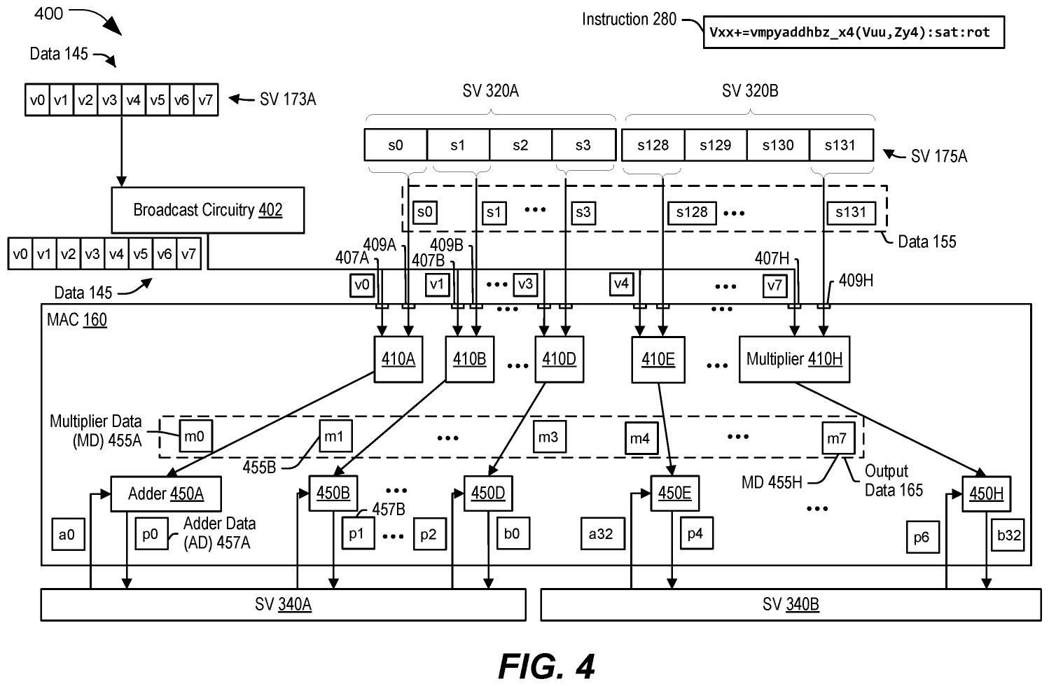

In some implementations, each processing stage includes multiple sub-stages, with a different SV provided from the source VR 154 to the MAC 160 as the data 155 in each sub-stage. For example, during a first sub-stage of the first processing stage, the MAC 160 receives the SV 175A as the data 155 from the source VR 154. The MAC 160 generates output data 165 based on the data 145 (received from the rotation VR file 140) and the data 155 (received from the source VR 154), as further described with reference to FIG. 4. In some implementations, elements of the data 145 are multiplied with elements of the data 155. For example, elements of the SV 173A received from the rotation VR 144A are multiplied in parallel with elements of the SV 175A received from the source VR 154. To illustrate, a first element of the SV 173A is multiplied by a first element of the SV 175A, a second element of the SV 173A is multiplied by a second element of the SV 175A, and so on. In some examples, an element of the SV 173A has the same size (e.g., includes the same count of bits) as an element of the SV 175A. In other examples, an element of the SV 173A has a different size (e.g., includes a different count of bits) as an element of the SV 175A. The MAC 160 stores the output data 165 in the accumulate VR 156 as the accumulate data 167.

If the vector 151 stored in the source VR 154 includes multiple sub-vector values, each processing stage can include multiple sub-stages. For example, during a second sub-stage of the first processing stage, the MAC 160 receives the SV 175B (e.g., a next sub-vector value) as the data 155 from the source VR 154. To illustrate, elements of the SV 173A received from the rotation VR 144A are multiplied in parallel with elements of the SV 175B received from the source VR 154. The MAC 160 generates the output data 165 based on the data 145 (e.g., the SV 173A) and the data 155 (e.g., the SV 175B). In some aspects, additional sub-stages of the first processing stage are performed with the MAC 160 processing the SV 173A and each of the SVs of the source VR 154 until the SV 173A and the SV 175S have been processed by the MAC 160.

During a rotation stage subsequent to the first processing stage, the rotators 172A-172M rotate data in one or more of the rotation VRs 144A-144N by a rotation amount, as further described with reference to FIG. 13. For example, the rotator 172A receives data 183 from the rotation VR 144A, rotates the data 183 by a rotation amount 174A to generate rotation data 177, and stores the rotation data 177 in the rotation VR 144A. Referring briefly to FIG. 1B, in an illustrative example 180, the SV 173A is stored in the dedicated portion 134A prior to rotation. To illustrate, the data 183 corresponds to the SV 173A followed by the SV 173B, one or more additional SVs, and the SV 173T. Subsequent to the rotation, the SV 173B is stored in the dedicated portion 134A of the rotation VR 144A. To illustrate, the rotation data 177 corresponds to the SV 173B followed by the one or more additional SVs, the SV 173T, and the SV 173A.

Returning to FIG. 1A, in some aspects, during an initial rotation after the vector 171 is loaded from the memory 132 to the rotation VR 144A, the data 183 is the same as the vector 171 retrieved from the memory 132. In some aspects, in a subsequent rotation, the data 183 corresponds to a rotated version of the vector 171. For example, in these aspects, the data 183 corresponds to the rotation data 177 generated in a previous rotation.

In some implementations, multiple rotators are used to generate the rotation data 177. For example, the rotator 172A rotates the data 183 by the rotation amount 174A to generate first rotation data, a second rotator of the rotators 172A-172M rotates the first rotation data by a second rotation amount to generate second rotation data, and so on until a rotator of the rotators 172A-172M rotates rotation data received from a prior rotator to generate the rotation data 177. The rotation circuitry 142 stores the rotation data 177 in the rotation VR 144A.

During a second processing stage, the selection circuitry 146 retrieves the data 145 (e.g., the SV 173B) from the dedicated portion 134A and provides the data 145 to the MAC 160. During a first sub-stage of the second processing stage, the MAC 160 receives the SV 175A as the data 155 from the source VR 154. The MAC 160 generates the output data 165 based on the SV 173B (e.g., the data 145) and the SV 175A (e.g., the data 155), and updates the accumulate data 167 based on the output data 165.

During a second sub-stage of the second processing stage, the MAC 160 receives the SV 175B as the data 155 from the source VR 154. The MAC 160 generates the output data 165 based on the SV 173B (e.g., the data 145) and the SV 175B (e.g., the data 155), and outputs the accumulate data 167 based on the output data 165. In some aspects, the additional sub-stages of the second processing stage are performed with the MAC 160 processing the SV 173B and each of the SVs of the source VR 154 until the SV 173B and the SV 175S have been processed by the MAC 160. In some aspects, additional rotation stages and processing stages are performed until all SVs 173A-173T of the vector 171 have been processed by the MAC 160 to update the accumulate VR 156.

The MAC 160 multiplying elements of a single SV retrieved from the rotation vector register 144A with elements of a single SV retrieved from the source VR 154 during each processing stage is provided as an illustrative example. In some implementations, the one or more processors 190 can include multiple copies of the components of the MAC 160 described herein that can be used to multiply elements of an SV retrieved from one of the rotation VRs 144A-144N with the elements of multiple SVs retrieved from the source VR 154. For example, during a first processing stage, a first copy of the components can multiply elements of the SV 173A with elements of the SV 175A in parallel with a second copy of the components multiplying elements of the SV 173A with elements of the SV 175B. In some implementations, the MAC 160 can multiply elements of the SV 173A in parallel with elements of two or more of the SV 175A-175S. During a rotation stage that is subsequent to the first processing stage, the SV 173A is rotated to the end of the rotation VR 144A, and the SV 173B is rotated to the dedicated portion 134A. During a second processing stage, the first copy of the components can multiply elements of the SV 173B with element of the SV 175A in parallel with a second copy of the components multiplying elements of the SV 173B with elements of the SV 175B. In some implementations, the MAC 160 can multiply elements of the SV 173B in parallel with elements of two or more of the SV 175A-175S.

In some implementations, the one or more processors 190 can include multiple copies of the components of the MAC 160 described herein that can be used to multiply elements of multiple SVs retrieved from the rotation VRs 144A-144N with elements of an SV retrieved from the source VR 154. For example, during a first processing stage, a first copy of the components can multiply elements of the SV 173A with elements of the SV 175A in parallel with a second copy of the components multiplying elements of the SV 173B with elements of the SV 175A. In a first aspect, the SV 173A and the SV 173B are retrieved from the same rotation VR (e.g., the rotation VR 144A). In a second aspect, the SV 173A is retrieved from the rotation VR 144A and the SV 173B is retrieved from the rotation VR 144B. During a rotation stage that is subsequent to the first processing stage, the SVs (e.g., the SV 173A, the SV 173B, one or more additional SVs, or a combination thereof) that have been provided to the components of the MAC 160 during the first processing stage are rotated. In the first aspect, the SV 173A, the SV 173B, the one or more additional SVs, or a combination thereof, are rotated to the end of the rotation VR 144A. In the second aspect, the SV 173A is rotated to the end of the rotation VR 144A, the SV 173B is rotated to the end of the rotation VR 144B, each of the one or more additional SVs is rotated to the end of a corresponding rotation VR, or a combination thereof.

The system 100 thus enables vector processing with reduced complexity of the selection circuitry 146. For example, the selection circuitry 146 is enabled to read data from the dedicated portion 134A of the rotation VR 144A and does not have to include circuitry to support reading from the remaining portions of the rotation VR 144A.

Referring to FIG. 2A, a diagram 200 of an illustrative aspect the one or more processors 190 and the memory 132 of the system 100 of FIG. 1A is shown. The one or more processors 190 are operable to rotate vector input for executing an instruction.

The one or more processors 190 include an instruction buffer 202 coupled to an instruction selector 204. The instruction selector 204 is coupled to the MAC 160 and to a load/store unit 208. The load/store unit 208 is coupled to the memory 132. In a particular aspect, the load/store unit 208 is coupled via one or more caches to the memory 132. For example, the load/store unit 208 is coupled via a L1 cache 232 to a L2 cache 234, and the L2 cache 234 is coupled to the memory 132. In some aspects, the load/store unit 208 is also coupled to the L2 cache 234 (bypassing the L1 cache 232). Each of the MAC 160 and the load/store unit 208 is coupled to the source VR 154, the rotation VR file 140, and the accumulate VR 156.

In a particular aspect, a plurality of instructions are added to an instruction set architecture (ISA). The ISA can support instructions corresponding to various configurations of the selection circuitry 146, the rotation circuitry 142, or both, various SV sizes for the rotation VRs 144A-144N, various SV sizes for the source VR 154, SVs having signed values, SVs having unsigned values, one or more source VRs to store the vector 151, one or more of the rotation VRs 144A-144N to store the vector 171, or a combination thereof. In some implementations, the one or more processors 190 correspond to a vector processor that implements the ISA. For example, the one or more processors 190 is configured to efficiently operate on vectors. In a particular aspect, the one or more processors 190 is configured to efficiently copy a vector (e.g., a large one-dimensional array of data) from the memory 132 to a vector register, and vice versa, and to perform parallel processing of multiple data values from a vector register, such as using multiple parallel computation lanes, in a single instruction multiple data (SIMD) configuration.

The instruction selector 204 uses various instruction selection techniques to select an instruction 280 (e.g., a multiply accumulate instruction) for processing from the instruction buffer 202. The instruction 280 includes an opcode 282 and a parameter 284. The opcode 282 indicates a type (e.g., multiply-accumulate) of the instruction 280. In a first implementation, the parameter 284 indicates a first memory address of the vector 171 and a second memory address of the vector 151. In the first implementation, during execution of the instruction 280, the vector 171 is loaded to at least one of the rotation VRs 144A-144N and the vector 151 is loaded to the source VR 154. In a second implementation, prior to execution of the instruction 280, the vector 171 is loaded to at least one of the rotation VRs 144A-144N and the vector 151 is loaded to the source VR 154. In the second implementation, the parameter 284 indicates the at least one of the rotation VRs 144A-144N and the source VR 154.

The instruction selector 204 provides the instruction 280 (or data representing aspects of the instruction 280) to the MAC 160, the load/store unit 208, or both. In some aspects, the instruction selector 204 initiates execution of the instruction 280 by providing the opcode 282 to the MAC 160.

In a first implementation, the parameter 284 indicates a first memory address of the vector 171 and a second memory address of the vector 151, and the instruction selector 204 provides the first memory address and the second memory address to the load/store unit 208. The load/store unit 208, in response to receiving the first memory address, performs a load operation 273 of the vector 171 to the rotation VR file 140. In a particular implementation, the load/store unit 208, in response to receiving the first memory address of the vector 171, loads the vector 171 from the L2 cache 234 to the rotation VR file 140. If the vector 171 is not available in the L2 cache 234, the load/store unit 208 copies the vector 171 from the received first memory address of the memory 132 to the L2 cache 234 and from the L2 cache 234 (e.g., bypassing the L1 cache 232) to the rotation VRs 144A-144N. Similarly, the load/store unit 208, in response to receiving the second memory address, performs a load operation 275 of the vector 151 to the source VR 154. In a particular implementation, the load/store unit 208, in response to receiving the second memory address, loads the vector 151 from the L2 cache 234 to the source VR 154. If the vector 151 is not available in the L2 cache 234, the load/store unit 208 copies the vector 151 from the received second memory address of the memory 132 to the L2 cache 234 and from the L2 cache 234 (e.g., bypassing the L1 cache 232) to the source VR 154.

The one or more processors 190 executes the instruction 280 to retrieve the data 145 from the rotation VR file 140, retrieve the data 155 from the source VR 154, process the data 145 and the data 155 at the MAC 160 to generate the output data 165, store the output data 165 in the accumulate VR 156, and rotate the data in the rotation VR 144A after the data 145 is retrieved from the rotation VR file 140. For example, executing the instruction 280 includes performing multiple processing stages, one or more rotation stages, or a combination thereof, to update the accumulate data 167, as described with reference to FIG. 1A.

In a particular aspect, the load/store unit 208, in response to determining that SVs 173A-173T of the vector 171 have been processed by the MAC 160, stores the accumulate data 167 to the memory 132. In some examples, the vector 171 corresponds to a portion of vector data, and the load/store unit 208, subsequent to the MAC 160 processing the vector 171, loads a next portion of the vector data as the vector 171 to the rotation VR 144A. In these examples, additional processing stages, rotation stages, and loads are performed until the entirety of the vector data has been processed.

Referring to FIG. 2B, a diagram 290 illustrates a change in performance (e.g., count of operations) versus a change in operational intensity (e.g., operations per byte) of the MAC 160.

During the first processing stage, the MAC 160 generates the output data 165 based on the vector 171 and the vector 151 loaded to the rotation VR file 140 and the source VR 154, respectively. In some implementations, the MAC 160 generates the output data 165 once the data 145 (e.g., the SV 173A) and the data 155 (e.g., the SV 175A) are loaded. In these implementations, the output data 165 is generated concurrently with loading of the remaining SVs of the vector 171 and the vector 151. In other implementations, the MAC 160 generates the output data 165 once all SVs of the vector 171 and all SVs of the vector 151 are loaded to the rotation VR file 140 and the source VR 154, respectively. The performance of the MAC 160 corresponds to the bandwidth for loading the vector 171 and the vector 151 from the memory 132 (or the L2 cache).

Once the vector 171 and the vector 151 are loaded, an “optimal” operational intensity of the MAC 160 is reached. For example, performance of the MAC 160 is not limited by the bandwidth because inputs to the MAC 160 are available in the rotation VR file 140 and the source VR 154. Rotating the data in the rotation VR file 140 to make the next sub-vector value available to the MAC 160 thus enables the MAC 160 to perform at high (e.g., optimal) operational intensity as compared to retrieving the next sub-vector value as a scalar value from the memory 132 as an input for the MAC 160.

FIGS. 3-11 illustrate an example of executing the instruction 280. The instruction 280 corresponds to a “vmpyaddhbz_x4” instruction, where “vmpyadd” indicates that a vector multiply accumulate (e.g., add) algorithm is implemented. The instruction 280 may have the form: Vxx+=vmpyaddhbz_x4(Vuu,Zy4):sat:rot, where Vxx is a destination VR (e.g., the accumulate VR 156), Vuu is a source VR (e.g., the source VR 154), Zy4 is a rotation VR (e.g., the rotation VR 144A), “sat” indicates that values are saturated, and “rot” indicates that a rotation stage is to be performed between processing stages.

Although examples herein describe the instruction 280 performing a vector multiply accumulate operation that reads data from a single source VR (e.g., the source VR 154), in other examples, the instruction 280 of the form Vxx+=vmpyaddzt_x8(Vuu,Vvv,Zy4):sat:rot indicates that data can be read from multiple source VRs, such as a first source VR represented by Vuu and a second source VR represented by Vvv.

Referring to FIG. 3, a diagram 300 of an illustrative aspect of a first state of the rotation VR 144A, the source VR 154, and the accumulate VR 156 is shown. In a particular aspect, the rotation VR 144, the source VR 154, and the accumulate VR 156 are in the first state prior to a first processing stage of execution of the instruction 280 of FIG. 2A.

In a particular implementation, the rotation VR 144A includes 64 elements (e.g., v0-v63), each of the elements v0-v63 includes a half-word value, and an SV includes 8 elements. For example, the SV 173A includes elements v0-v7, the SV 173B includes elements v8-v15, and so on. In the first processing state, the SV 173A is stored in the dedicated portion 134A of the rotation VR 144A. In a particular aspect, the SV 173A can include multiple SVs. For example, the SV 173A includes an SV 312A (e.g., v0-v3) and an SV 312B (e.g., v4-v7).

In a particular implementation, the source VR 154 includes 256 elements (e.g., s0-s255), and each of the elements s0-s255 includes a byte value. In a particular aspect, an SV of the source VR 154 includes 4 elements. For example, an SV 320A includes elements s0-s3, and an SV 320B includes elements s128-s131. In a particular aspect, the SV 175A includes the SV 320A and the SV 320B.

In a particular implementation, the accumulate VR 156 includes 64 elements (e.g., a0-a63). For example, the accumulate VR 156 includes an SV 340A (e.g., a0), an SV 340B (e.g., a32), one or more additional SVs, or a combination thereof.

In the first state illustrated by the diagram 300, prior to the first processing stage, the selection circuitry 146 is configured to select the SV 173A stored in the dedicated portion 134A as the data 145 for the first processing stage, which is described further with reference to FIG. 4.

Referring to FIG. 4, a diagram 400 of an illustrative aspect of operation of components of the system 100 of FIG. 1A during a first sub-stage of the first processing stage of execution of the instruction 280 is shown.

In a particular example, the instruction 280 has the form: Vxx+=vmpyaddhbz_x4(Vuu,Zy4):sat:rot, and a processing stage of execution of the instruction 280 corresponds to the following pseudocode for loop:

```
fHIDE(int i;) for (i=0;i<32;i++) {
  fHIDE(size8s_t acc[2];) acc[0] = Vxx.V32s[i];
  acc[0] += fMPY8SS(Vuu.V8s[4*i+0], ZyV.V16s[0]);
  acc[0] += fMPY8SS(Vuu.V8s[4*i+1], ZyV.V16s[1]);
  acc[0] += fMPY8SS(Vuu.V8s[4*i+2], ZyV.V16s[2]);
  acc[0] += fMPY8SS(Vuu.V8s[4*i+3], ZyV.V16s[3]);
  acc[1] = Vxx.V32s[32+i];
  acc[1] += fMPY8SS(Vuu.V8s[128+4*i+0], ZyV.V16s[4]);
  acc[1] += fMPY8SS(Vuu.V8s[128+4*i+1], ZyV.V16s[5]);
  acc[1] += fMPY8SS(Vuu.V8s[128+4*i+2], ZyV.V16s[6]);
  acc[1] += fMPY8SS(Vuu.V8s[128+4*i+3], ZyV.V16s[7]);
  Vxx.V32s[i] = fVSATN(32,acc[0]);
  Vxx.V32s[32+i] = fVSATN(32,acc[1]);
}
```

where Vxx corresponds to the accumulate VR 156, acc[0] corresponds to the SV 340A, acc[1] corresponds to the SV 340B, Vuu corresponds to the source VR 154, ZyV corresponds to the rotation VR 144A, V8s indicates a byte value, V16s indicates a half-word value, and fMPY8SS indicates signed floating point multiply. Each iteration of the for loop corresponds to a sub-stage of a processing stage.

During a first sub-stage of the first processing stage, the selection circuitry 146 selects the SV 173A as the data 145, as described with reference to FIG. 1A. The one or more processors 190 include broadcast circuitry 402 coupled to the MAC 160. The MAC 160 includes a plurality of multipliers, e.g., a multiplier 410A, a multiplier 410B, a multiplier 410D, a multiplier 410E, one or more additional multipliers, a multiplier 410H, or a combination hereof, that are referred to herein as multipliers 410A-410H.

The MAC 160 includes multiple inputs, a pair of inputs of the multiple inputs associated with a corresponding multiplier. In some aspects, the MAC 160 includes inputs 407A-H configured to couple with the broadcast circuitry 402, and inputs 409A-H configured to couple with the source VR 154. For example, an input 407A of the MAC 160 corresponds to (e.g., includes or is coupled to) a first input of the multiplier 410A, an input 407B of the MAC 160 corresponds to (e.g., includes or is coupled to) a first input of the multiplier 410B, and so on. As another example, an input 409A of the MAC 160 corresponds to (e.g., includes or is coupled to) a second input of the multiplier 410A, an input 409B of the MAC 160 corresponds to (e.g., includes or is coupled to) a second input of the multiplier 410B, and so on. In some aspects, the inputs 407A-H and the inputs 409A-H enable parallel multiplication of elements of the data 145 with elements of the data 155. For example, the multiplier 410A multiplies a data element received from the input 407A with a data element received from the input 409A, the multiplier 410B multiplies a data element received from the input 407B with a data element of the data 155 received from the input 409B, and so on.

In a particular implementation, the broadcast circuitry 402 includes multiple outputs, and each of the multiple outputs is coupled to a corresponding input of the MAC 160 associated with a single multiplier. For example, a first output of the broadcast circuitry 402 is coupled to the input 407A associated with the multiplier 410A and not coupled to inputs associated with any of the multipliers 410B-410H. As another example, a second output of the broadcast circuitry 402 is coupled to the input 407B associated with the multiplier 410B and not coupled to inputs associated with other multipliers of the multipliers 410A-410H. In a particular aspect, one or more of the multiple outputs of the broadcast circuitry 402, one or more of the multiple inputs of the MAC 160 (e.g., the inputs 407A-H and the inputs 409A-H), or a combination thereof, include one or more bus interfaces, one more latches, one or more flip-flops, one or more buffers, other data buffering circuitry, or a combination thereof.

In a particular aspect, the selection circuitry 146 provides the data 145 (e.g., the SV 173A) to the broadcast circuitry 402. The data 145 (e.g., the SV 173A) includes multiple elements (e.g., v0-v7). The broadcast circuitry 402 provides the data 145 to the multipliers 410A-410H. For example, the broadcast circuitry 402, for each of the multiple elements (e.g., v0-v7), provides the element to a respective distinct input of the inputs 407A-H of the MAC 160. To illustrate, a first element (e.g., v0) is provided via a first output of the broadcast circuitry 402 to the input 407A associated with the multiplier 410A, and not provided by the broadcast circuitry 402 to any input associated with other multipliers of the MAC 160. Similarly, a second element (e.g., v1) is provided via a second output of the broadcast circuitry 402 to the input 407B associated with the multiplier 410B, and not provided by the broadcast circuitry 402 to any input associated with other multipliers of the MAC 160.

The data 155 (e.g., the SV 175A) includes multiple elements (e.g., s0-s3 and s128-s131). The MAC 160 receives the data 155 (e.g., the SV 175A) from the source VR 154, as described with reference to FIG. 1A. For example, for each element of the multiple elements (e.g., s0-s3 and s128-s131), the element is provided to a respective distinct input of the inputs 409A-H of the MAC 160. To illustrate, a first element (e.g., s0) is provided to the input 409A associated with the multiplier 410A, a second element (e.g., s1) is provided to the input 409B associated with the multiplier 410B, and so on.

The multipliers 410A-410H generate output data 165 based on the data 145 (e.g., the SV 173A) and the data 155 (e.g., the SV 175A). For example, the multipliers 410A-410H generate multiplier data 455A-455H as the output data 165. To illustrate, the multiplier 410A receives the first element (e.g., v0) of the data 145 (e.g., the SV 173A) via the input 407A, and receives the first element (e.g., s0) of the data 155 (e.g., the SV 175A) via the input 409A. The multiplier 410A generates multiplier data 455A (e.g., m0, an output SV) by multiplying the first element (e.g., v0) of the data 145 (e.g., the SV 173A) and the first element (e.g., s0) of the data 155 (e.g., the SV 175A). Similarly, the multiplier 410B receives the second element (e.g., v1) of the data 145 (e.g., the SV 173A) via the input 407B, and receives the second element (e.g., s1) of the data 155 (e.g., the SV 175A) via the input 409B. The multiplier 410B generates multiplier data 455B (e.g., m1, an output SV) by multiplying the second element (e.g., v1) of the data 145 (e.g., the SV 173A) and the second element (e.g., s1) of the data 155 (e.g., the SV 175A).

The MAC 160 provides the output data 165 to the accumulate VR 156. In a particular aspect, the output data 165 is added to the accumulate data 167 and the result is stored in the accumulate VR 156. For example, the MAC 160 includes multiple adders, such as an adder 450A, an adder 450B, an adder 450D, an adder 450E, an adder 450H, one or more additional adders, or a combination thereof, that are referred to herein as adders 450A-450H. The adders 450A-450H receive at least a portion of the accumulate data 167 from the accumulate VR 156, generate a sum by adding the output data 165 to the accumulate data 167, and overwrite the portion of the accumulate data 167 with the sum in the accumulate VR 156.

For example, the adder 450A receives the SV 340A (e.g., a value represented by a0) from the accumulate VR 156 and receives the multiplier data 455A (e.g., a value represented by m0) from the multiplier 410A. The adder 450A generates adder data 457A (e.g., a value represented by p0) by adding the SV 340A (e.g., a0) and the multiplier data 455A (e.g., m0), and stores the adder data 457A (e.g., p0) as an updated value of the SV 340A in the accumulate VR 156. Similarly, the adder 450B receives the SV 340A (e.g., p0) from the accumulate VR 156 and receives the multiplier data 455B (e.g., a value represented by m1) from the multiplier 410B. The adder 450B generates adder data 457B (e.g., a value represented by p1) by adding the SV 340A (e.g., p0) and the multiplier data 455B (e.g., m1), and stores the adder data 457B (e.g., p1) as an updated value of the SV 340A in the accumulate VR 156. At the end of the first sub-stage, the SV 340A has been updated from a first value (e.g., a0) to a second value (e.g., a value represented by b0), and the SV 340B has been updated from a first value (e.g., a value represented by a32) to a second value (e.g., a value represented by b32).

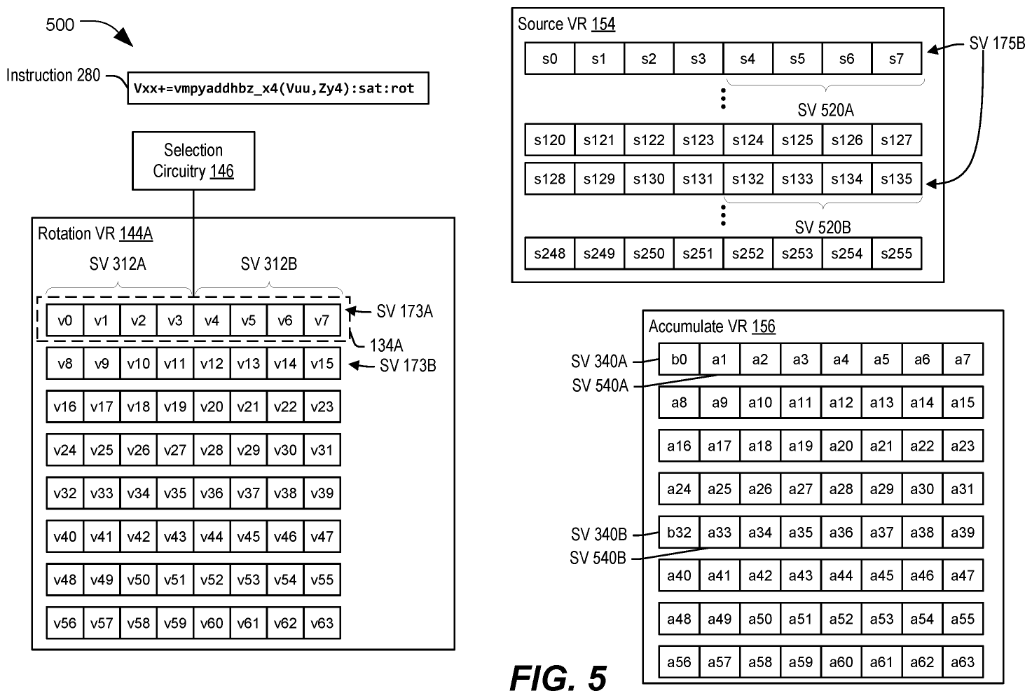

Referring to FIG. 5, a diagram 500 of an illustrative aspect of a second state of the rotation VR 144A, the source VR 154, and the accumulate VR 156 is shown. In a particular aspect, the rotation VR 144A, the source VR 154, and the accumulate VR 156 are in the second state subsequent to the first sub-stage and prior to a second sub-stage of the first processing stage of execution of the instruction 280 of FIG. 2A.

In the second state, the SV 173A remains in the dedicated portion 134A. The SV 175B of the source VR 154 includes an SV 520A and an SV 520B. The accumulate VR 156 includes an SV 540A (e.g., a1) and an SV 540B (e.g., a33). The SV 540A (e.g., a1) is next to the SV 340A (e.g., b0) that was updated in the first sub-stage of the first processing stage. The SV 540B (e.g., a33) is next to the SV 340B (e.g., b32) that was updated in the first sub-stage of the first processing stage.

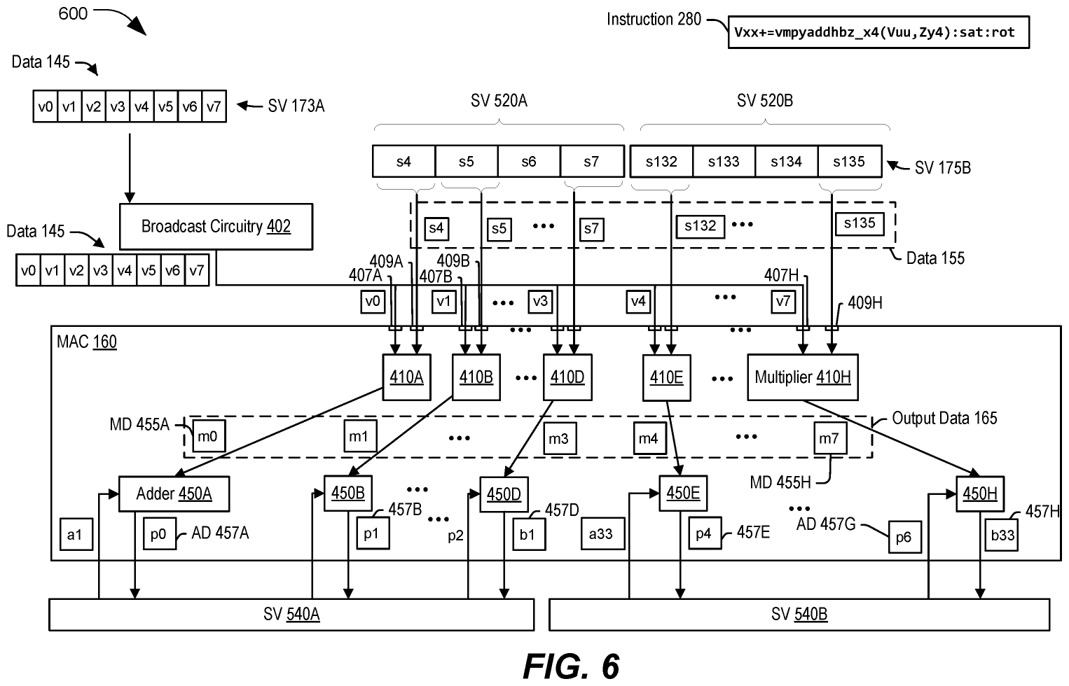

Referring to FIG. 6, a diagram 600 of an illustrative aspect of operation of components of the system 100 of FIG. 1A during a second sub-stage of the first processing stage of execution of the instruction 280 is shown.

During a second sub-stage of the first processing stage, the MAC 160 receives the SV 175B as the data 155 from the source VR 154, as described with reference to FIG. 1A. The SV 175B includes multiple elements (e.g., s4-s7 and s132-s135). For each element of the multiple elements (e.g., s4-s7 and s132-s135), the element is provided to a respective distinct input of the inputs 409A-H of the MAC 160. To illustrate, a first element (e.g., s4) is provided to the input 409A associated with the multiplier 410A, a second element (e.g., s5) is provided to the input 409B associated with the multiplier 410B, and so on.

The multipliers 410A-410H generate output data 165 based on the data 145 (e.g., the SV 173A) and the data 155 (e.g., the SV 175B). For example, the multipliers 410A-410H generate multiplier data 455A-455H as the output data 165. To illustrate, the multiplier 410A generates multiplier data 455A (e.g., m0, an output SV) by multiplying the first element (e.g., v0) of the data 145 (e.g., the SV 173A) and the first element (e.g., s4) of the data 155 (e.g., the SV 175B). Similarly, the multiplier 410B generates multiplier data 455B (e.g., m1, an output SV) by multiplying the second element (e.g., v1) of the data 145 (e.g., the SV 173A) and the second element (e.g., s5) of the data 155 (e.g., the SV 175B).

The MAC 160 provides the output data 165 to the accumulate VR 156. For example, the adder 450A receives the SV 540A (e.g., a value represented by a1) from the accumulate VR 156 and receives the multiplier data 455A (e.g., a value represented by m0) from the multiplier 410A. The adder 450A generates adder data 457A (e.g., a value represented by p0) by adding the SV 540A (e.g., a1) and the multiplier data 455A (e.g., m0), and stores the adder data 457A (e.g., p0) as an updated value of the SV 540A in the accumulate VR 156. Similarly, the adder 450B receives the SV 540A (e.g., p0) from the accumulate VR 156 and receives the multiplier data 455B (e.g., a value represented by m1) from the multiplier 410B. The adder 450B generates adder data 457B (e.g., a value represented by p1) by adding the SV 540A (e.g., p0) and the multiplier data 455B (e.g., m1), and stores the adder data 457B (e.g., p1) as an updated value of the SV 540A in the accumulate VR 156. At the end of the second sub-stage, the SV 540A has been updated from a first value (e.g., a1) to a second value (e.g., a value represented by b1), and the SV 540B has been updated from a first value (e.g., a value represented by a33) to a second value (e.g., a value represented by b33).

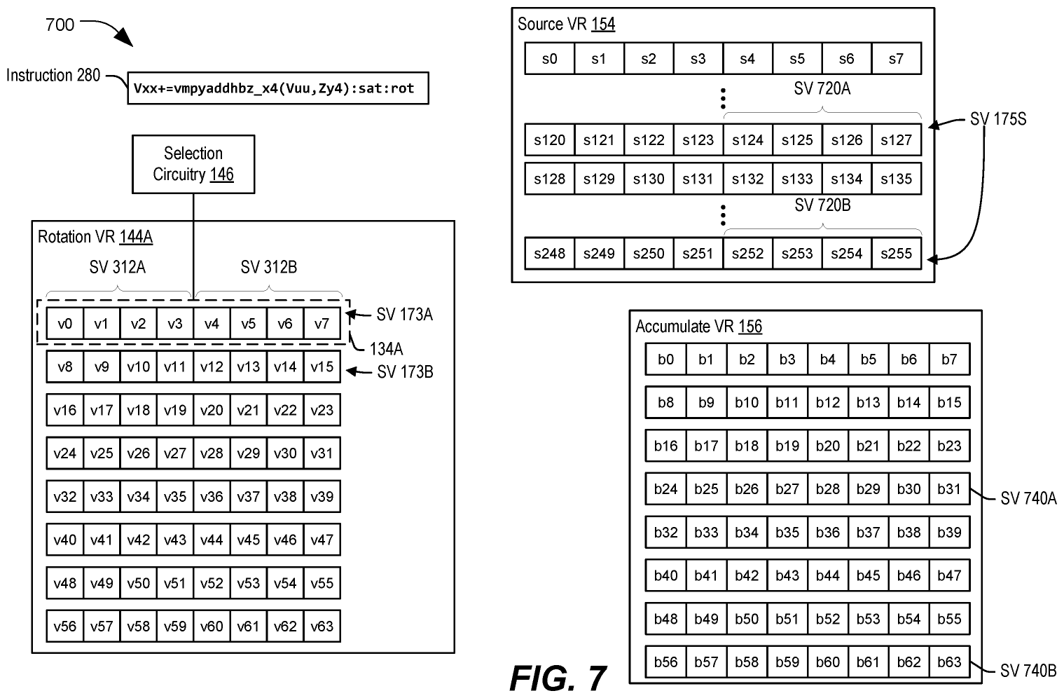

Referring to FIG. 7, a diagram 700 of an illustrative aspect of a third state of the rotation VR 144A, the source VR 154, and the accumulate VR 156 is shown. In a particular aspect, the rotation VR 144A, the source VR 154, and the accumulate VR 156 are in the third state subsequent to the first processing stage and prior to a second processing stage of execution of the instruction 280 of FIG. 2A.

In the third state, the SV 173A remains in the dedicated portion 134A. The SV 175S of the source VR 154 includes an SV 720A and an SV 720B. All elements of the accumulate VR 156 have been updated based on the SV 173A and the SVs 175A-175S. For example, the accumulate VR 156 includes an SV 740A that has been updated from a first value (e.g., a31) to a second value (e.g., b31) and an SV 740B that has been updated from a first value (e.g., a63) to a second value (e.g., b63).

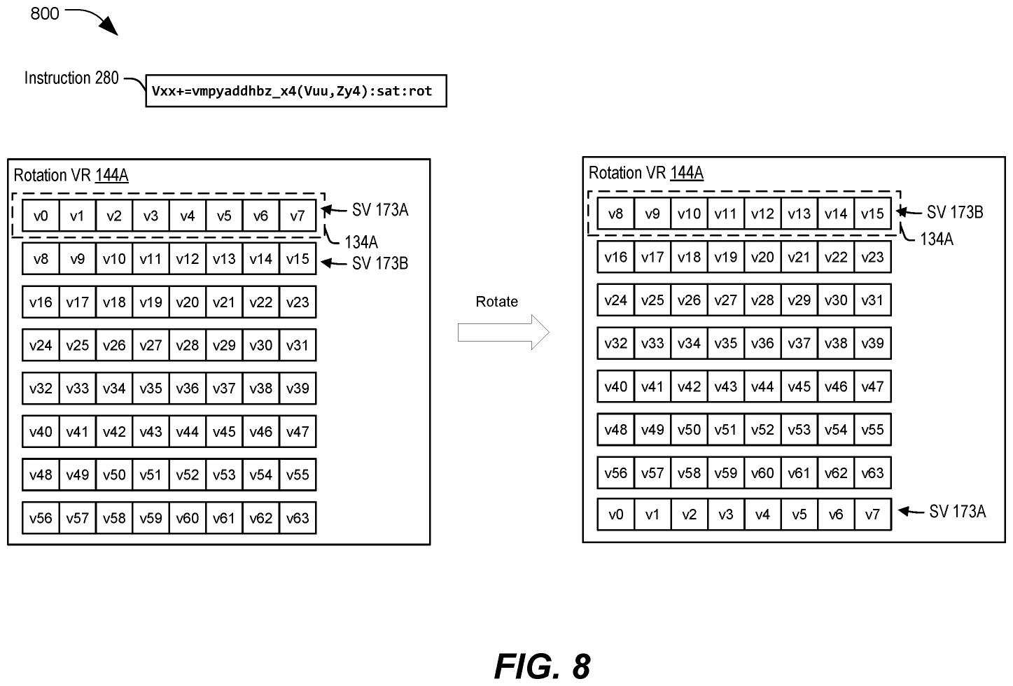

Referring to FIG. 8, a diagram 800 of an illustrative aspect of rotation of data of the rotation VR 144A of FIG. 1 during execution of the instruction 280 is shown. For example, the rotation circuitry 142 of FIG. 1A rotates the data of the rotation VR 144A, as described with reference to FIGS. 1A-1B. In a particular aspect, the rotation is performed during a rotation stage subsequent to the first processing stage. During the rotation, the SV 173A is moved to the end of the rotation VR 144A and the rest of the SVs are shifted such that the SV 173B is stored in the dedicated portion 134A.

In a particular example, the instruction 280 has the form: Vxx+=vmpyaddhbz_x4(Vuu,Zy4):sat:rot, and a rotation stage of execution of the instruction 280 corresponds to the following pseudocode for loop:

```
fHIDE(size1u_t tmp;) fHIDE(int k;) fHIDE(int a;) fHIDE(int b;) for
(k=0;k<128−2*8;k++) {
  a = k % 128;
  b = (k + 128 − 2*8) % 128;
  tmp = ZyV.V8u[a];
  ZyV.V8u[a] = ZyV.V8u[b];
  ZyV.V8u[b] = tmp;
}
```

where ZyV corresponds to the rotation VR 144A.

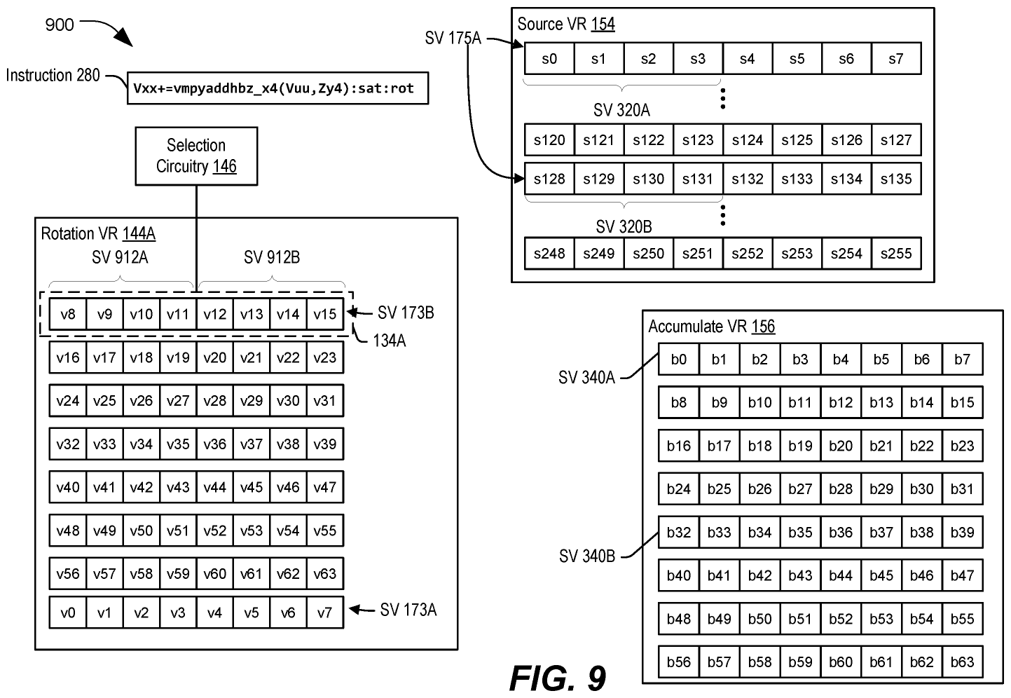

Referring to FIG. 9, a diagram 900 of an illustrative aspect of a fourth state of the rotation VR 144A, the source VR 154, and the accumulate VR 156 is shown. In a particular aspect, the rotation VR 144A, the source VR 154, and the accumulate VR 156 are in the fourth state after the rotation stage of FIG. 8 and prior to a second processing stage of execution of the instruction 280 of FIG. 2A.

In the second processing state, the SV 173B is stored in the dedicated portion 134A of the rotation VR 144A. In a particular aspect, the SV 173B can include multiple SVs. For example, the SV 173B includes an SV 912A (e.g., v8-v11) and an SV 912B (e.g., v12-v15).

The source VR 154 includes the SV 175A, and the SV 175A includes the SV 320A and the SV 320B. The accumulate VR 156 includes the SV 340A (e.g., b0), and the SV 340B (e.g., b32). In a particular aspect, the selection circuitry 146 is configured to select the SV 173B stored in the dedicated portion 134A as the data 145.

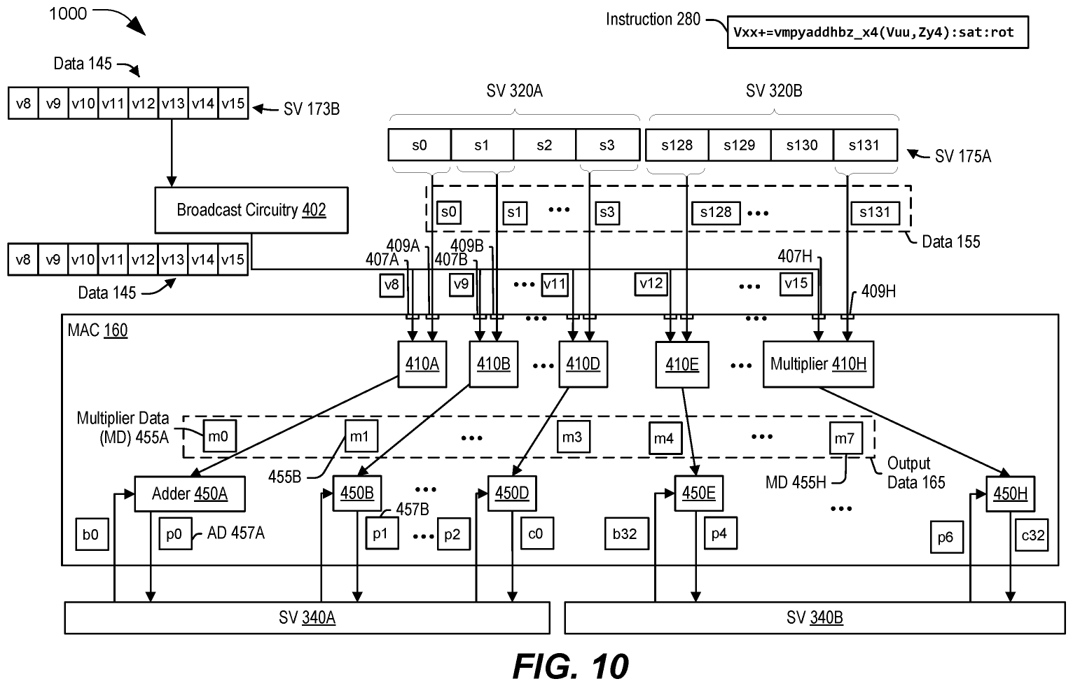

Referring to FIG. 10, a diagram 1000 of an illustrative aspect of operation of components of the system 100 of FIG. 1A during a first sub-stage of the second processing stage of execution of the instruction 280 of FIG. 2A is shown.

During a first sub-stage of the second processing stage, similar operations are performed as described with reference to the first sub-stage of the first processing stage of FIG. 4. For example, the selection circuitry 146 provides the data 145 (e.g., the SV 173B) to the broadcast circuitry 402. The data 145 (e.g., the SV 173A) includes multiple elements (e.g., v8-v15). The broadcast circuitry 402 provides the data 145 (e.g., the SV 173B) to the multipliers 410A-410H. For example, a first element (e.g., v8) of the data 145 (e.g., the SV 173B) is provided via a first output of the broadcast circuitry 402 to the input 407A associated with the multiplier 410A, a second element (e.g., v9) of the data 145 (e.g., the SV 173B) is provided via a second output of the broadcast circuitry 402 to the input 407B associated with the multiplier 410B, and so on.

The data 155 (e.g., the SV 175A) includes multiple elements (e.g., s0-s3 and s128-s131). The MAC 160 receives the data 155 (e.g., the SV 175A) from the source VR 154, as described with reference to FIG. 1A. For example, a first element (e.g., s0) is provided to the input 409A associated with the multiplier 410A, a second element (e.g., s1) is provided to the input 409B associated with the multiplier 410B, and so on.

The multipliers 410A-410H generate output data 165 based on the data 145 (e.g., the SV 173B) and the data 155 (e.g., the SV 175A). For example, the multiplier 410A generates multiplier data 455A by multiplying the first element (e.g., v8) of the data 145 (e.g., the SV 173B) and the first element (e.g., s0) of the data 155 (e.g., the SV 175A). Similarly, the multiplier 410B generates multiplier data 455B by multiplying the second element (e.g., v9) of the data 145 (e.g., the SV 173B) and the second element (e.g., s1) of the data 155 (e.g., the SV 175A).

The MAC 160 provides the output data 165 to the accumulate VR 156. The adder 450A receives the SV 340A (e.g., a value represented by b0) from the accumulate VR 156 and receives the multiplier data 455A (e.g., a value represented by m0) from the multiplier 410A. The adder 450A generates adder data 457A (e.g., a value represented by p0) by adding the SV 340A (e.g., b0) and the multiplier data 455A (e.g., m0), and stores the adder data 457A (e.g., p0) as an updated value of the SV 340A in the accumulate VR 156. Similarly, the adder 450B receives the SV 340A (e.g., p0) from the accumulate VR 156 and receives the multiplier data 455B (e.g., a value represented by m1) from the multiplier 410B. At the end of the first sub-stage, the SV 340A has been updated from a first value (e.g., b0) to a second value (e.g., a value represented by c0), and the SV 340B has been updated from a first value (e.g., a value represented by b32) to a second value (e.g., a value represented by c32).

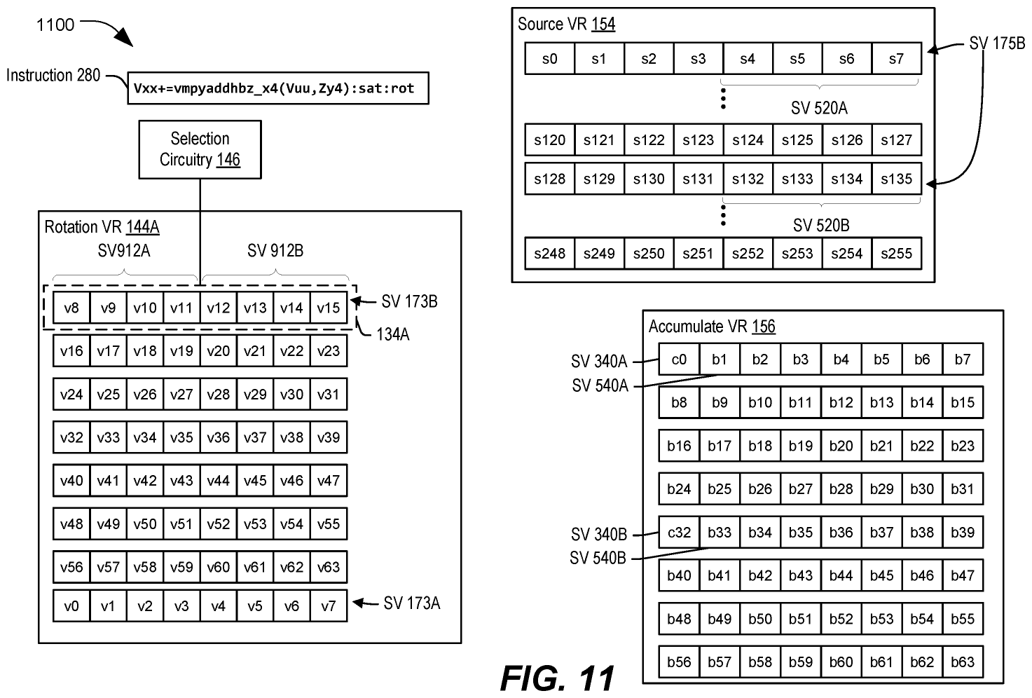

Referring to FIG. 11, a diagram 1100 of an illustrative aspect of a fifth state of the rotation VR 144A, the source VR 154, and the accumulate VR 156 is shown. In a particular aspect, the rotation VR 144A, the source VR 154, and the accumulate VR 156 are in the fifth state subsequent to the first sub-stage and prior to a second sub-stage of the second processing stage of execution of the instruction 280.

In the fifth state, the SV 173B remains in the dedicated portion 134A. The SV 175B of the source VR 154 includes the SV 520A and the SV 520B. The accumulate VR 156 includes the SV 540A (e.g., b1) and the SV 540B (e.g., b33). The SV 540A (e.g., b1) is next to the SV 340A (e.g., c0) that was updated in the first sub-stage of the second processing stage. The SV 540B (e.g., b33) is next to the SV 340B (e.g., c32) that was updated in the first sub-stage of the second processing stage. In a second sub-stage of the second processing stage, the SV 540A and the SV 540B are updated based on the SV 173B and the SV 175B. In a particular aspect, additional sub-stages of the second processing stage are performed until the accumulate data 167 has been updated based on the SV 173B and all of the SVs 175A-175S. In a particular aspect, additional rotation stages and processing stages are performed until all of the SVs 173A-173T have been processed by the MAC 160 to update the accumulate data 167.

Referring to FIG. 12, a diagram 1200 of an illustrative aspect of operation of the selection circuitry 146 is shown. The selection circuitry 146 is coupled to the rotation VRs 144A-144N. For example, the selection circuitry 146 is coupled to a rotation VR 144A and a rotation VR 144B. The selection circuitry 146 being coupled to two rotation VRs is provided as an illustrative example. In other examples, the selection circuitry 146 may be coupled to fewer than two or more than two rotation VRs.

In a particular aspect, the selection circuitry 146 is configured to access data stored in dedicated portions of the rotation VRs 144A-144N and not from remaining portions of the rotation VRs 144A-144N. For example, the selection circuitry 146 is configured to access data from a dedicated portion 134A of the rotation VR 144A. As another example, the selection circuitry 146 is configured to access data from a dedicated portion 134B of the rotation VR 144B.

As an illustrative example, prior to or during a first processing stage of executing the instruction 280 of FIG. 2A, a write data 1271 (e.g., performed by the load/store unit 208 of FIG. 2A) stores a first portion of the vector 171 as a data portion 1211 in a rotation VR 144A, and stores a second portion of the vector 171 as a data portion 1213 in a rotation VR 144B. In a particular aspect, the first portion of the vector 171 includes alternating SVs of the vector 171, and the second portion of the vector 171 includes remaining SVs of the vector 171. For example, the data portion 1211 includes the SV 173A (e.g., v0-v7) of the vector 171, and the data portion 1213 includes the SV 173B (e.g., v8-15) of the vector 171. Similarly, the data portion 1211 includes an SV 173C (e.g., v16-v23) and the data portion 1213 includes an SV 173D (e.g., v24-v31), and so on. The data portion 1211 thus includes half (e.g., 32 elements: v0-v7, v16-v23, v32-v39, and v48-v55) of the vector 171 and the data portion 1213 includes a remaining half (e.g., the other 32 elements: v8-v15, v24-v31, v40-v47, and v56-v63) of the vector 171. Thus, the rotation VR 144A is illustrated as storing 32 elements of the vector 171 and the rotation VR 144B is illustrated as storing the other 32 elements of the vector 171. In some implementations, such as illustrated in FIG. 3, each of the rotation VR 144A and the rotation VR 144B is sized to store 64 elements, and therefore some storage capacity of each of the rotation VR 144A and the rotation VR 144B is unused. In some implementations, rather than having portions of the rotation VR 144A and the rotation VR 144B being unused, data of a next vector to be processed may also be loaded into the rotation VR 144A and the rotation VR 144B (e.g., using a next write data 1271 operation). In other implementations, each of the rotation VR 144A and the rotation VR 144B has a storage capacity of 32 elements and therefore no storage capacity is unused.

It should be understood that each of the rotation VR 144A and the rotation VR 144B is shown as storing a vector of data (e.g., 1 column by 32 rows of elements) for ease of illustration. In other examples, each of the rotation vector 144A or the rotation VR 144B can store data in various logical and/or physical arrangements, such as an array representation (e.g., 8 columns by 4 rows of elements or 4 columns by 8 rows of elements).

In a particular aspect, an SV 1273A corresponding to the first 8 elements of the data portion 1211 is stored in a dedicated portion 134A of the rotation VR 144A, and an SV 1273B corresponding to the first 8 elements of the data portion 1213 is stored in a dedicated portion 134B of the rotation VR 144B.

In the illustrated example, the first 8 elements of the data portion 1211 correspond to the SV 173A (e.g., v0-v7) and the first 8 elements of the data portion 1213 corresponds to the SV 173B (e.g., v8-v15). In this example, the SV 1273A corresponds to the SV 173A and the SV 1273B corresponds to the SV 173B. In an example in which a rotated data portion is written to the rotation VR 144A, as further described with reference to FIG. 13, the SV 1273A includes the first 8 elements of the rotated data portion (e.g., v16-v23).

The selection circuitry 146 includes components that enable various portions of data from the dedicated portion 134A of the rotation VR 144A, the dedicated portion 134B of the rotation VR 144B, or both, to be output by the selection circuitry 146 based on one or more control signals. In a particular aspect, the selection circuitry 146 includes a multiplexer 1230 coupled to the rotation VR 144B. A multiplexer 1232 is coupled to the rotation VR 144A and to the multiplexer 1230. A delay element 1234 is coupled to the multiplexer 1232. A combiner 1236 is coupled to the rotation VR 144A and the multiplexer 1230. A multiplexer 1238 is coupled to the rotation VR 144A, the delay element 1234, the combiner 1236, and the multiplexer 1230.

In some implementations, the write data 1271, concurrently with providing the data portion 1213 to the rotation VR 144B, provides the SV 1273B that is to be stored in the dedicated portion 134B of the rotation VR 144B to the multiplexer 1230. In a particular aspect, the multiplexer 1230 is configured to select the SV 1273B retrieved from the dedicated portion 134B of the rotation VR 144B or the SV 1273B received via the write data 1271. For example, the multiplexer 1230 selects the SV 1273B from the dedicated portion 134B or from the write data 1271 based on one or more control signals, such as a register output indicator 1224, a rotate indicator 1226, one or more additional control signals, or a combination thereof.

In a particular aspect, a first value (e.g., 1) of the rotate indicator 1226 indicates that the write data 1271 (e.g., performed by the rotation circuitry 142 of FIG. 1A) is writing rotated data to at least one of the rotation VR 144A or the rotation VR 144B. A second value (e.g., 0) of the rotate indicator 1226 indicates that rotated data is not being written to either of the rotation VR 144A or the rotation VR 144B. In a particular aspect, a first value (e.g., 1) of the register output indicator 1224 indicates that the SV from the write data 1271 is to be selected. A second value (e.g., 0) of the register output indicator 1224 indicates that the SV from the dedicated portion 134B is to be selected.

In a particular implementation, the multiplexer 1230 selects the SV 1273B from the write data 1271 in response to the rotate indicator 1226 having the first value, the register output indicator 1224 having the first value, or both. Alternatively, the multiplexer 1230 selects the SV 1273B from the dedicated portion 134B in response to the rotate indicator 1226 having the second value, the register output indicator 1224 having the second value, or both. In some aspects, selecting the SV 1273B from the write data 1271 enables the multiplexer 1230 to generate an output without waiting for the write data 1271 to complete writing the data portion 1213 to the rotation VR 144B.

The multiplexer 1230 provides an SV 1231A (e.g., initial 4 elements) of the SV 1273B (e.g., the selected SV 1273B) to the multiplexer 1238, and provides an SV 1231B (e.g., last 4 elements) of the SV 1273B to the multiplexer 1232. In the illustrated example, the SV 1273B corresponds to the SV 173B, the SV 1231A corresponds to the SV 912A (e.g., v8-v11), and the SV 1231B corresponds to the SV 912B (e.g., v12-v15).

In a particular aspect, the multiplexer 1230 provides an SV 1216 (e.g., initial 2 elements) of the SV 1273B (e.g., the selected SV 1273B) to the combiner 1236. In the illustrated example, the SV 1273B corresponds to the SV 173B and the SV 1216 corresponds to initial 2 elements (e.g., v8-v9) of the SV 173B.

The multiplexer 1232 receives the SV 1212B (e.g., the last 4 elements) of the SV 1273A from the rotation VR 144A, and receives the SV 1231B (e.g., the last 4 elements) of the SV 1273B (e.g., the selected SV 1273B) from the multiplexer 1230. The multiplexer 1232 outputs, based on a control signal (e.g., a register indicator 1228), the SV 1212B or the SV 1231B. For example, the multiplexer 1232, in response to the register indicator 1228 having a first value (e.g., 0), selects the SV 1212B (e.g., the last 4 elements) of the SV 1273A as the multiplexer output 1233. Alternatively, the multiplexer 1232, in response to the register indicator 1228 having a second value (e.g., 1), selects the SV 1231B (e.g., the last 4 elements) of the SV 1273B as the multiplexer output 1233.

The combiner 1236 is configured to receive an SV 1214 (e.g., the initial 2 elements) of the SV 1273A and an SV 1216 (e.g., the initial 2 elements) of the SV 1273B. The combiner 1236 generates an SV 1218 by combining the SV 1214 and the SV 1216. In the illustrated example, the SV 1273A corresponds to the SV 173A, the SV 1273B corresponds to the SV 173B, and the SV 1218 corresponds to a combination of the initial 2 elements (e.g., v0-v1) of the SV 173A and the initial 2 elements (e.g., v8-v9) of the SV 173B.

The multiplexer 1238 receives the SV 1212A (e.g., the initial 4 elements of the SV 1273A) from the rotation VR 144A, the SV 1218 (e.g., the initial 2 elements of the SV 1273A and the initial 2 elements of the SV 1273B), and the SV 1231A (e.g., the initial 4 elements of the SV 1273B). The multiplexer 1238, based on a control signal (e.g., a patterning control 1242), selects one of the SV 1212A, the SV 1218, and the SV 1231A to output as an initial part of a multiplexer output 1239.

The delay element 1234 receives the multiplexer output 1233 (e.g., the last 4 elements of the 1273A or the last 4 elements of the 1273B) and provides the multiplexer output 1233 from the delay element 1234 to the multiplexer 1238 subsequent to the output of the initial part of the multiplexer output 1239. The multiplexer 1238 outputs the multiplexer output 1233 (e.g., the last 4 elements of the 1273A or the last 4 elements of the 1273B) as a second part of the multiplexer output 1239. The data 145 includes the initial part of the multiplexer output 1239 (e.g., the initial 4 elements of the SV 1273A, the initial 2 elements of the SV 1273A and the initial 2 elements of the SV 1273B, or the initial 4 elements of the SV 1273B), and the second part of the multiplexer output 1239 (e.g., the last 4 elements of the 1273A or the last 4 elements of the 1273B).

In the illustrated example, the SV 1273A corresponds to the SV 173A, and the multiplexer 1238 outputs the initial 4 elements of the SV 173A (e.g., v0-v3) as the initial part of the multiplexer output 1239, and outputs the last 4 elements of the SV 173A (e.g., v4-v7) as the second part of the multiplexer output 1239. During a first processing stage, the data 145 includes the initial 4 elements of the SV 173A (e.g., v0-v3) and the last 4 elements of the SV 173A (e.g., v4-v7). Subsequent to the first processing stage, the rotation circuitry 142 rotates the data in the rotation VR 144A during a first rotation stage, as further described with reference to FIG. 13.

In an example with two rotation VRs, during a second processing stage, the selection circuitry 146, outputs SVs from the dedicated portion 134B of the rotation VR 144B. For example, the multiplexer 1238 outputs the initial 4 elements of the SV 173B (e.g., v8-v11) as an initial part of the multiplexer output 1239, and outputs the last 4 elements of the SV 173B (e.g., v12-v15) as a second part of the multiplexer output 1239. During the second processing stage, the data 145 includes the initial 4 elements of the SV 173B (e.g., v8-v11) and the last 4 elements of the SV 173B (e.g., v12-v15). Subsequent to the second processing stage, the rotation circuitry 142 rotates the data in the rotation VR 144B during a second rotation stage, as further described with reference to FIG. 13.

During a third processing stage, the selection circuitry 146, outputs SVs from the dedicated portion 134A of the rotation VR 144A that includes the rotated data. For example, the multiplexer 1238 outputs the initial 4 elements of the SV 1273A (e.g., v16-v19) as an initial part of the multiplexer output 1239, and outputs the last 4 elements of the SV 1273A (e.g., v20-v23) as a second part of the multiplexer output 1239. During the third processing stage, the data 145 includes the initial 4 elements of the SV 1273A (e.g., v16-v19) and the last 4 elements of the SV 1273A (e.g., v20-v23). Subsequent to the third processing stage, the rotation circuitry 142 rotates the data in the rotation VR 144A during a third rotation stage, as further described with reference to FIG. 13. In some aspects, additional processing stages and rotation stages are performed until all elements of the data portion 1211 and the data portion 1213 have been output by the selection circuitry 146 and processed by the MAC 160.

The particular pattern of outputting first 8 elements of the rotation VR 144A followed by the first 8 elements of the rotation VR 144B during each processing stage is provided as an illustrative example. In other examples, elements stored in the dedicated portion 134A, elements stored in the dedicated portion 134B, or a combination thereof, can be output by the selection circuitry 146 in various combinations based on the configuration 148. For example, the configuration 148 specifies the values of the control signals (e.g., the register output indicator 1224, the rotate indicator 1226, the register indicator 1228, the patterning control 1242, or a combination thereof).

In some aspects, the selection circuitry 146 can, based on the configuration 148, output the data 145 including one or more elements from the dedicated portion 134A and one or more elements from the dedicated portion 134B in the same processing stage. For example, when the patterning control 1242 of the configuration 148 indicates that the data 145 is to include the SV 1218, the data 145 includes the initial elements stored in the dedicated portion 134A and the initial elements stored in the dedicated portion 134B. As another example, based on the register indicator 1228 and the patterning control 1242 of the configuration 148, the selection circuitry 146 can output the initial elements of one of the dedicated portion 134A (e.g., the SV 1212A) or the dedicated portion 134B (e.g., the SV 1231A) in a first timestep of a processing stage, and output the last elements of the other of the dedicated portion 134A (e.g., the SV 1212B) or the dedicated portion 134B (e.g., the SV 1231B) in a second timestep of the same processing stage.

In a particular aspect, the configuration 148 is based on default data, a configuration setting, user input, etc. In a particular aspect, the configuration 148 is based on data that maps the instruction 280 (e.g., the opcode 282, the parameter 284, or both) to the configuration 148 indicating particular values for the control signals.

Referring to FIG. 13, a diagram 1300 of an illustrative aspect of operation of the rotation circuitry 142 is shown. The rotation circuitry 142 is coupled to the rotation VRs 144A-144N. For example, the rotation circuitry 142 is coupled to the rotation VR 144A and the rotation VR 144B. The rotation circuitry 142 being coupled to two rotation VRs is provided as an illustrative example. In other examples, the rotation circuitry 142 may be coupled to fewer than two or more than two rotation VRs.

The rotation circuitry 142 is configured to rotate data in the rotation VR 144A or the rotation VR 144B based on one or more control signals (e.g., a register indicator 1324 and a register indicator 1326) and based on one or more rotation amounts (e.g., a rotation amount 174A and a rotation amount 174B). The rotation circuitry 142 includes a logic gate 1302 (e.g., a two input AND gate) and a logic gate 1304 (e.g., a two input AND gate). An input of the logic gate 1302 is coupled to an output of the rotation VR 144A, and another input of the logic gate 1302 is configured to receive the register indicator 1324. An input of the logic gate 1304 (e.g., a two input AND gate) is coupled to an output of the rotation VR 144B and another input of the logic gate 1304 is configured to receive the register indicator 1326.

The logic gate 1302 and the logic gate 1304 are coupled to a logic gate 1306 (e.g., a two input OR gate). For example, an input of the logic gate 1306 is coupled to an output of the logic gate 1302 and another input of the logic gate 1306 is coupled to an output of the logic gate 1304. The logic gate 1306 is coupled to the rotators 172A-172M of FIG. 1A.

In some implementations, each of the rotators 172A-172M is configured to rotate data by a pre-determined amount. In these implementations, the rotation circuitry 142 can include one or more of the rotators 172A-172M. For example, an output of the logic gate 1306 is coupled to an input of a rotator 172A, and an output of the rotator 172A is coupled to an input of a rotator 172B. In some examples, the output of the rotator 172A is coupled, via a pipeline register, to the input of the rotator 172B. In a particular aspect, the rotator 172A is configured to rotate data by the rotation amount 174A and store the rotated data in the pipeline register, and the rotator 172B is configured to selectively rotate data retrieved from the pipeline register by the rotation amount 174B based on a control signal. For example, the rotator 172B rotates data by the rotation amount 174B when the control signal has a first value (e.g., 1). The rotator 172B refrains from rotating data when the control signal has a second value (e.g., 0). An output of the rotator 172B is coupled to an input of the rotation VR 144A and an input of the rotation VR 144B. In some alternative implementations, the rotation circuitry 142 includes a single programmable rotator (e.g., the rotator 172A). In these implementations, an output of the logic gate 1306 is coupled to an input of the rotator 172A, and an output of the rotator 172A is coupled to an input of the rotation VR 144A and an input of the rotation VR 144B. In some examples, the rotator 172A and the rotation VR 144A together function as a variable shift register.

The logic gate 1302, responsive to the register indicator 1324 having a first value (e.g., 1), provides the data portion 1211 received from the rotation VR 144A to the logic gate 1306. The logic gate 1304, responsive to the register indicator 1326 having a first value (e.g., 1), provides the data portion 1213 received from the rotation VR 144B to the logic gate 1306. In some aspects (e.g., subsequent to a processing stage), one of the register indicator 1324 or the register indicator 1326 has the first value (e.g., 1), and the other of the register indicator 1324 or the register indicator 1326 has a second value (e.g., 0). In these aspects, either the data portion 1211 or the data portion 1213 is passed to the logic gate 1306 for rotation. In some aspects (e.g., during a processing stage), the register indicator 1324 and the register indicator 1326 both have the second value (e.g., 0) so that neither the data portion 1211 nor the data portion 1213 is passed to the logic gate 1306, and no rotation is performed.

The logic gate 1306 passes the data portion 1211 or the data portion 1213 received from the logic gate 1302 or the logic gate 1304, respectively, to the rotator 172A as output 1307. For example, subsequent to a first processing stage, the register indicator 1324 has the first value (e.g., 1), the logic gate 1302 passes the data portion 1211 to the logic gate 1306, and the logic gate 1306 provides the data portion 1211 as the output 1307 to the rotator 172A. The rotator 172A rotates the output 1307 by the rotation amount 174A (e.g., 2 half words) to generate rotation data 1377 and provides the rotation data 1377 to the rotator 172B. In some examples, the rotator 172A provides the rotation data 1377 to a pipeline register, and the rotator 172B retrieves the rotation data 1377 from the pipeline register. The rotator 172B generates the rotation data 177 by rotating the rotation data 1377 based on the rotation amount 174B (e.g., 6 half words). The rotation circuitry 142 stores the rotation data 177 in the rotation VR 144A. For example, the rotation circuitry 142, responsive to the register indicator 1324 having the first value (e.g., 1), stores the rotation data 177 in the rotation VR 144A. Alternatively, the rotation circuitry 142, responsive to the register indicator 1326 having the first value (e.g., 1), stores the rotation data 177 in the rotation VR 144B.

The rotation mechanism including a pipeline register is provided as an illustrative example. In other implementations, the rotator 172A and the rotation VR 144A (or the rotation VR 144B) together function as a first shift register, and the rotator 172B and the rotation VR 144A (or the rotation VR 144B) together function as a second shift register. In an example, the rotator 172A rotates bit values stored in the rotation VR 144A independently of (e.g., without) any additional registers such that the rotation data 1377 is stored in the rotation VR 144A subsequent to the rotation. In another example, the rotator 172B rotates bits values corresponding to the rotation data 1377 stored in the rotation VR 144A independently of (e.g., without) any additional registers such that the rotation data 177 is stored in the rotation VR 144A subsequent to the rotation.

In some examples, the rotation circuitry 142 rotates data in a single one of the rotation VRs 144A-144N during a rotation stage. In some examples, the rotation circuitry 142 rotates data in multiple rotation VRs of the rotation VRs 144A-144N during a rotation stage. For example, one of the register indicator 1324 or the register indicator 1326 has the first value (e.g., 1) during a first pass and the other of the register indicator 1324 or the register indicator 1326 has the first value (e.g., 1) during a second pass.

In some aspects, the rotation circuitry 142 is configurable. For example, the one or more control signals, the one or more rotation amounts, or a combination thereof, are based on a configuration 1348 of the rotation circuitry 142. The configuration 1348 can be based on default data, user input, a configuration setting, etc. In a particular aspect, the configuration 1348 is based on data that maps the instruction 280 (e.g., the opcode 282, the parameter 284, or both) to the configuration 1348 indicating particular values for the one or more control signals, the one or more rotation amounts, or both. In some aspects, at least one of the rotation amounts is selectable. In an example, the rotation amount 174A is fixed (e.g., 2 half words), and the rotation amount 174B is selectable. To illustrate, the rotation amount 174B has a value (e.g., a selection of 0 half words or 6 half words) based on the configuration 1348.

In some aspects, the rotation circuitry 142 enables rotating data in a single rotation VR, as described with reference to FIGS. 3-11. For example, the register indicator 1324 has the first value (e.g., 1) subsequent to each processing stage of an instruction. In some aspects, the rotation circuitry 142 enables rotating data in alternating rotation VRs subsequent to processing stages, as described with reference to FIG. 12. For example, the register indicator 1324 has the first value (e.g., 1) subsequent to the first processing stage and every odd-numbered processing stage after the first processing stage, and the register indicator 1326 has the first value (e.g., 1) subsequent to the second processing stage and every even-numbered processing stage after the second processing stage.

In a particular example, when the configuration 148 of the selection circuitry 146 indicates that the dedicated portion 134A of the rotation VR 144A is to be selected for a particular processing stage, the configuration 1348 indicates that data in the rotation VR 144A (e.g., and not data in any other rotation VR) is to be rotated during a rotation stage that is subsequent to the particular processing stage. For example, the register indicator 1324 has a first value (e.g., 1) and the rotation amount 174B is selected to indicate 6 half-words to have a total rotation of 8 half-words that includes 2 half-words indicated by the rotation amount 174A.

In some examples, the rotation circuitry 142 enables rotating data in multiple rotation VRs during a single rotation stage. For example, when the configuration 148 of the selection circuitry 146 indicates that the two initial elements of the dedicated portion 134A of the rotation VR 144A and the two initial elements of the dedicated portion 134B of the rotation VR 144B are to be selected (e.g., as described with reference to the SV 1218 of FIG. 12) during a particular processing stage, the configuration 1348 indicates that data in the rotation VR 144A and data in the rotation VR 144B are to be rotated during a rotation stage that is subsequent to the particular processing stage. For example, the rotation amount 174B is selected to indicate 0 half-words to have a total rotation of 2 half-words that includes 2 half-words indicated by the rotation amount 174A. During a first pass of the rotation stage, the register indicator 1324 has a first value (e.g., 1) and the data in the rotation VR 144A is rotated by 2 half-words. During a second pass of the rotation stage, the register indicator 1326 has a first value (e.g., 1) and the data in the rotation VR 144B is rotated by 2 half-words.

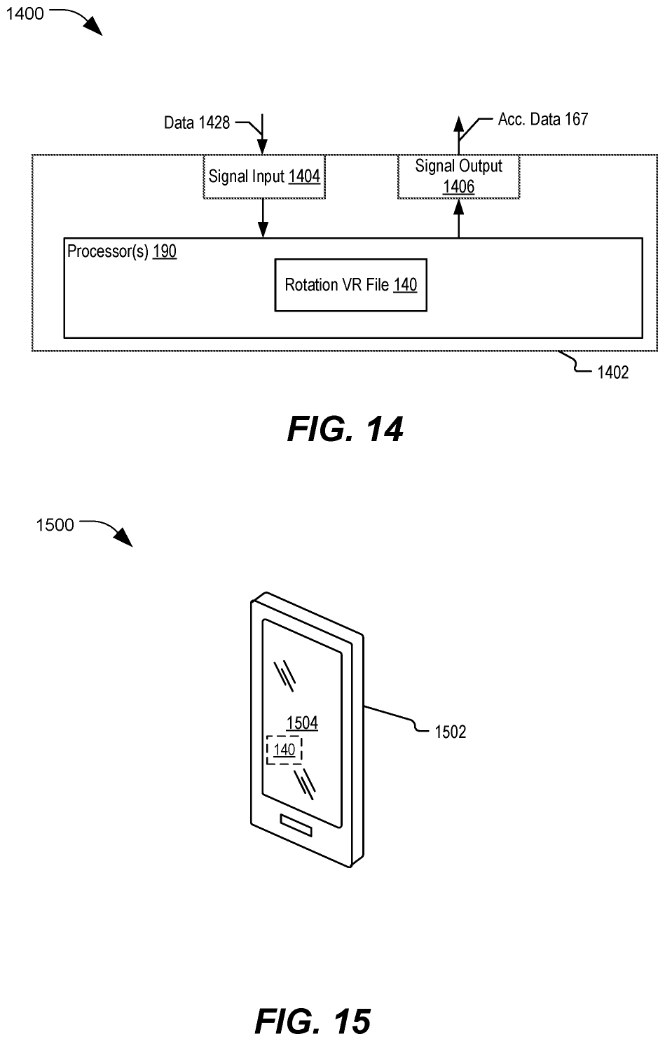

FIG. 14 depicts an implementation 1400 of the device 102 as an integrated circuit 1402 that includes the one or more processors 190. The one or more processors 190 includes the rotation VR file 140. In some aspects, the one or more processors 190 also include the MAC 160, the VR file 150, or both. The integrated circuit 1402 also includes a signal input 1404, such as one or more bus interfaces, one more latches, one or more flip-flops, one or more buffers, other data buffering circuitry, or a combination thereof, to enable data 1428 to be received for processing. In an example, the data 1428 includes the vector 171, the vector 151 of FIG. 1A, or both. The integrated circuit 1402 also includes a signal output 1406, such as a bus interface, to enable sending of an output signal, such as the accumulate data 167. The integrated circuit 1402 enables implementation of rotating vector input as a component in a system, such as a mobile phone or tablet as depicted in FIG. 15, a headset as depicted in FIG. 16, a wearable electronic device as depicted in FIG. 17, a voice-controlled speaker system as depicted in FIG. 18, a camera as depicted in FIG. 19, a virtual reality, mixed reality, or augmented reality headset as depicted in FIG. 20, or a vehicle as depicted in FIG. 21 or FIG. 22.

FIG. 15 depicts an implementation 1500 in which the device 102 includes a mobile device 1502, such as a phone or tablet, as illustrative, non-limiting examples. The mobile device 1502 includes a display screen 1504. Components of the one or more processors 190, including the rotation VR file 140, are integrated in the mobile device 1502 and are illustrated using dashed lines to indicate internal components that are not generally visible to a user of the mobile device 1502. In some aspects, the one or more processors 190 also include the MAC 160, the VR file 150, or both. In a particular example, the rotation VR file 140 operates to rotate data in rotation VRs during performance of vector operations (e.g., matrix multiplications), and the results of the vector operations are then processed to perform one or more operations at the mobile device 1502, such as to launch a graphical user interface or otherwise display other information associated with the vector operations at the display screen 1504 (e.g., via an integrated “smart assistant” application).

In some implementations, the device 102 includes one or more other sensors or components that generate data that can be operated on by a vector operation using the instruction 280, such as wireless network signal data, global positioning data or other location data, video or image data from one or more cameras, inertial measurement or other movement data from an inertial measurement unit (e.g., one or more gyroscopes, compasses, accelerometers, etc.), or health data such as heart rate data, oxygen level data, respiratory data, etc. from one or more corresponding sensors, as illustrative, non-limiting examples. The vector operation generates output data that can be output or that can be processed to generate processed data, either or both of which may be displayed via the display screen 1504, output via a loudspeaker, transmitted via a wireless network to another device such as a wearable electronic device (e.g., a smart watch or headset), or output via a haptic output signal, as illustrative, non-limiting examples.

FIG. 16 depicts an implementation 1600 in which the device 102 includes a headset device 1602. Components of the one or more processors 190, including the rotation VR file 140, are integrated in the headset device 1602. In some aspects, the one or more processors 190 also include the MAC 160, the VR file 150, or both. In a particular example, the rotation VR file 140 operates to rotate data in rotation VRs during performance of vector operations (e.g., matrix multiplications), which may cause the headset device 1602 to perform one or more operations at the headset device 1602, to transmit data to a second device (not shown) for further processing, or a combination thereof.

FIG. 17 depicts an implementation 1700 in which the device 102 includes a wearable electronic device 1702, illustrated as a “smart watch.” The rotation VR file 140 is integrated into the wearable electronic device 1702. In some aspects, the MAC 160, the VR file 150, or both, are also integrated into the wearable electronic device 1702. In a particular example, the rotation VR file 140 operates to rotate data in rotation VRs during performance of vector operations (e.g., matrix multiplications), which may cause the wearable electronic device 1702 to perform one or more operations at the wearable electronic device 1702, such as to launch a graphical user interface or otherwise display other information associated with the vector operations at a display screen 1704 of the wearable electronic device 1702. To illustrate, the wearable electronic device 1702 may include a display screen that is configured to display a notification based on the vector operations performed by the wearable electronic device 1702. In a particular example, the wearable electronic device 1702 includes a haptic device that provides a haptic notification (e.g., vibrates) in response to performance of an operation that uses the vector operations, such as a neural network-based speech interface. For example, the haptic notification can cause a user to look at the wearable electronic device 1702 to see a displayed notification indicating performance of the vector operations (e.g., an action performed in response to identifying a user's spoken query). The wearable electronic device 1702 can thus alert a user with a hearing impairment or a user wearing a headset regarding an operation that uses the vector operations.

FIG. 18 is an implementation 1800 in which the device 102 includes a wireless speaker and voice activated device 1802. The wireless speaker and voice activated device 1802 can have wireless network connectivity and is configured to execute an assistant operation. The one or more processors 190 including the rotation VR file 140 are included in the wireless speaker and voice activated device 1802. In some aspects, the one or more processors 190 also include the MAC 160, the VR file 150, or both. The wireless speaker and voice activated device 1802 also includes a speaker 1804. During operation, the wireless speaker and voice activated device 1802 can execute assistant operations, such as via execution of a voice activation system (e.g., an integrated assistant application). The assistant operations can include adjusting a temperature, playing music, turning on lights, etc. For example, the assistant operations are performed responsive to receiving a command after a keyword or key phrase (e.g., “hello assistant”). In a particular example, the rotation VR file 140 operates to rotate data in rotation VRs during performance of vector operations (e.g., matrix multiplications), which may cause, or be part of computations associated with, performance of one or more operations at the wireless speaker and voice activated device 1802.

FIG. 19 depicts an implementation 1900 in which the device 102 includes a portable electronic device that corresponds to a camera device 1902. The rotation VR file 140 is included in the camera device 1902. In some aspects, the MAC 160, the VR file 150, or both, are also included in the camera device 1902. During operation, the camera device 1902 can execute operations responsive to spoken user commands, such as to adjust image or video capture settings, image or video playback settings, or image or video capture instructions, as illustrative examples. In a particular example, the rotation VR file 140 operates to rotate data in rotation VRs during performance of vector operations (e.g., matrix multiplications associated with image filtering), which may cause, or be part of computations associated with, performance of one or more operations at the camera device 1902.

FIG. 20 depicts an implementation 2000 in which the device 102 includes a portable electronic device that corresponds to a virtual reality, mixed reality, or augmented reality headset 2002. The rotation VR file 140 is integrated into the headset 2002. In some aspects, the MAC 160, the VR file 150, or both, are also integrated into the headset 2002. In a particular example, the rotation VR file 140 operates to rotate data in rotation VRs during performance of vector operations (e.g., matrix multiplications associated with image processing), which may cause, or be part of computations associated with, performance of one or more operations at the headset 2002. A visual interface device is positioned in front of the user's eyes to enable display of augmented reality, mixed reality, or virtual reality images or scenes to the user while the headset 2002 is worn. In a particular example, the visual interface device is configured to display a notification indicating performance of an operation (e.g., an image processing operation) that is based on the vector operations. To illustrate, the visual interface device is configured to display one or more images generated by the image processing operation.

FIG. 21 depicts an implementation 2100 in which the device 102 corresponds to, or is integrated within, a vehicle 2102, illustrated as a manned or unmanned aerial device (e.g., a package delivery drone). The rotation VR file 140 is integrated into the vehicle 2102. In some aspects, the MAC 160, the VR file 150, or both, are also integrated into the vehicle 2102. In a particular example, the rotation VR file 140 operates to rotate data in rotation VRs during performance of vector operations (e.g., matrix multiplications associated with an image processing operation), which may cause, or be part of computations associated with, performance of one or more operations at the vehicle 2102. For example, images generated by the image processing operation may be displayed by the vehicle 2102 to provide assembly instructions to a package recipient.

FIG. 22 depicts another implementation 2200 in which the device 102 corresponds to, or is integrated within, a vehicle 2202, illustrated as a car. The vehicle 2202 includes the one or more processors 190 including the rotation VR file 140. In some aspects, the one or more processors 190 also include the MAC 160, the VR file 150, or both. In a particular example, the rotation VR file 140 operates to rotate data in rotation VRs during performance of vector operations (e.g., matrix multiplications), which may cause the vehicle 2202 to perform one or more operations at the vehicle 2202.

In a particular aspect, a voice activation system initiates one or more operations of the vehicle 2202 based on one or more keywords (e.g., “unlock,” “start engine,” “play music,” “display weather forecast,” or another voice command) detected in an output signal of a microphone, such as by providing feedback or information via a display 2220 or one or more speakers. In some examples, the one or more keywords are detected in the output signal by performing operations, such as neural network computations in an artificial intelligence (AI) based automatic speech recognition system, that are based on vector operations that use the rotation VR file 140.

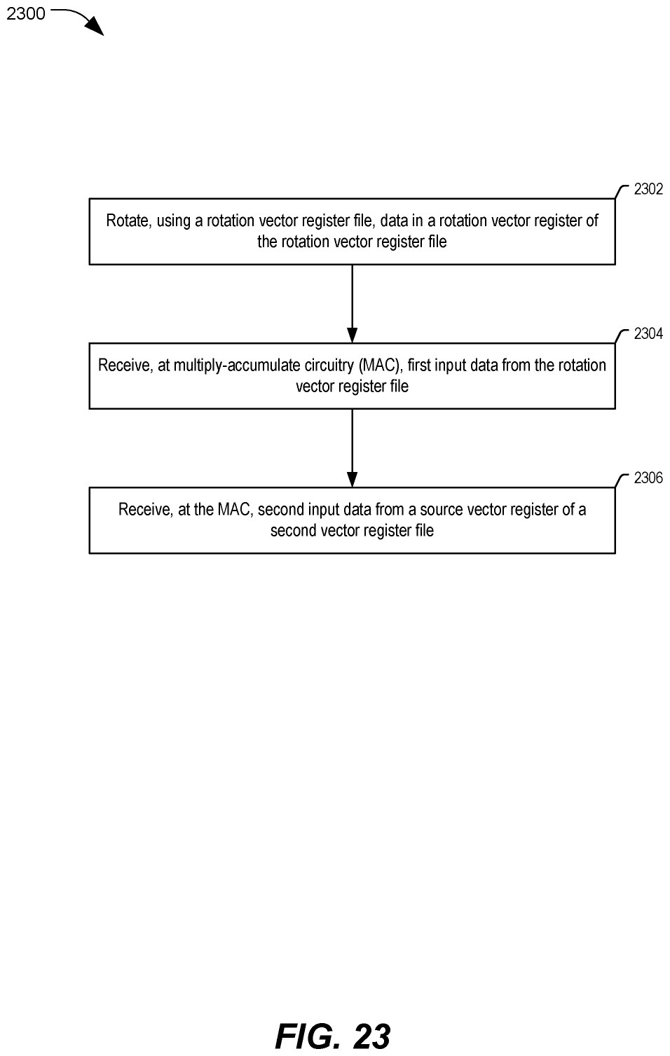

Referring to FIG. 23, a particular implementation of a method 2300 of rotating vector input is shown. In a particular aspect, one or more operations of the method 2300 (e.g., a processor-implemented method) are performed by at least one of the rotators 172A-172M, the rotation circuitry 142, the rotation VRs 144A-144N, the selection circuitry 146, the rotation VR file 140, the MAC 160, the VR file 150, the source VR 154, the accumulate VR 156, the one or more processors 190, the device 102, the system 100 of FIG. 1A, or a combination thereof.

The method 2300 includes rotating, using a rotation vector register file, data in a rotation vector register of the rotation vector register file, at 2302. For example, the rotation VR file 140 of FIG. 1A rotates data in the rotation VR 144A of the rotation VR file 140, as described with reference to FIGS. 1A, 1B, and 13.

The method 2300 also includes receiving, at multiply-accumulate circuitry (MAC), first input data from the rotation vector register file, at 2304. For example, the MAC 160 of FIG. 1A receives the data 145 from the rotation VR file 140, as described with reference to FIGS. 1A and 12.

The method 2300 further includes receiving, at the MAC, second input data from a source vector register of a second vector register file, at 2306. For example, the MAC 160 of FIG. 1A receives the data 155 from the source VR 154 of the VR file 150, as described with reference to FIG. 1A.

In some examples, the method 2300 includes generating, using the MAC, an output based on the first input data and the second input data. For example, the MAC 160 of FIG. 1A generates the output data 165 based on the data 145 and the data 155, as described with reference to FIG. 1A. The method 2300 also includes storing the output in an accumulate vector register of the second vector register file. For example, the MAC 160 of FIG. 1A stores the output data 165 in the accumulate VR 156 of the VR file 150, as described with reference to FIG. 1A.

The method 2300 enables vector processing with reduced complexity of the selection circuitry 146. For example, the selection circuitry 146 is enabled to read data that is rotated into the dedicated portion 134A of the rotation VR 144A and does not have to include circuitry to support reading from the remaining portions of the rotation VR 144A.

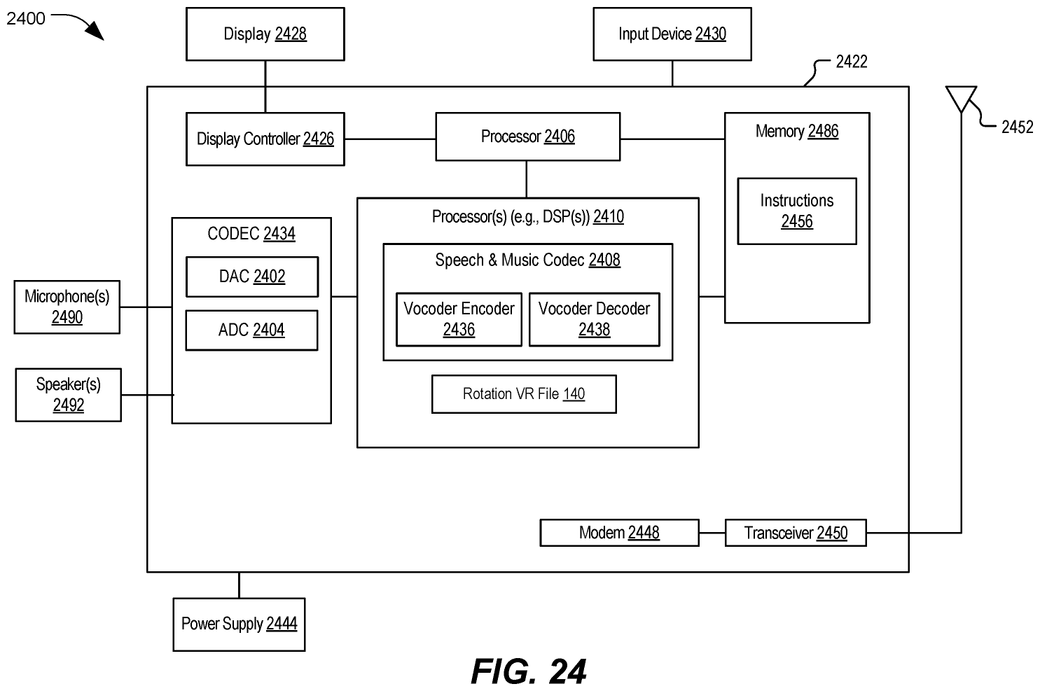

The method 2300 of FIG. 23 may be implemented by a field-programmable gate array (FPGA) device, an application-specific integrated circuit (ASIC), a processing unit such as a central processing unit (CPU), a DSP, a graphics processing unit (GPU), a controller, another hardware device, firmware device, or any combination thereof. As an example, the method 2300 of FIG. 23 may be performed by a processor that executes instructions, such as described with reference to FIG. 24.

Referring to FIG. 24, a block diagram of a particular illustrative implementation of a device is depicted and generally designated 2400. In various implementations, the device 2400 may have more or fewer components than illustrated in FIG. 24. In an illustrative implementation, the device 2400 may correspond to the device 102. In an illustrative implementation, the device 2400 may perform one or more operations described with reference to FIGS. 1A-23.

In a particular implementation, the device 2400 includes a processor 2406 (e.g., a CPU). The device 2400 may include one or more additional processors 2410 (e.g., one or more DSPs, one or more GPUs, or a combination thereof). In a particular aspect, the one or more processors 190 of FIG. 1A corresponds to the processor 2406, the processors 2410, or a combination thereof. The processors 2410 may include a speech and music coder-decoder (CODEC) 2408 that includes a voice coder (“vocoder”) encoder 2436, a vocoder decoder 2438, the rotation VR file 140, or a combination thereof.

The device 2400 may include a memory 2486 and a CODEC 2434. The memory 2486 may include instructions 2456, that are executable by the one or more additional processors 2410 (or the processor 2406) to implement the functionality described with reference to the rotation VR file 140. The device 2400 may include a modem 2448 coupled, via a transceiver 2450, to an antenna 2452.

The device 2400 may include a display 2428 coupled to a display controller 2426. One or more speakers 2492 and one or more microphones 2490 may be coupled to the CODEC 2434. The CODEC 2434 may include a digital-to-analog converter (DAC) 2402, an analog-to-digital converter (ADC) 2404, or both. In a particular implementation, the CODEC 2434 may receive analog signals from the one or more microphones 2490, convert the analog signals to digital signals using the analog-to-digital converter 2404, and provide the digital signals to the speech and music codec 2408. The speech and music codec 2408 may process the digital signals. In a particular implementation, the speech and music codec 2408 may provide digital signals to the CODEC 2434. The CODEC 2434 may convert the digital signals to analog signals using the digital-to-analog converter 2402 and may provide the analog signals to the one or more speakers 2492.

In a particular implementation, the device 2400 may be included in a system-in-package or system-on-chip device 2422. In a particular implementation, the memory 2486, the processor 2406, the processors 2410, the display controller 2426, the CODEC 2434, and the modem 2448 are included in the system-in-package or system-on-chip device 2422. In a particular implementation, an input device 2430 and a power supply 2444 are coupled to the system-in-package or the system-on-chip device 2422. Moreover, in a particular implementation, as illustrated in FIG. 24, the display 2428, the input device 2430, the one or more speakers 2492, the one or more microphones 2490, the antenna 2452, and the power supply 2444 are external to the system-in-package or the system-on-chip device 2422. In a particular implementation, each of the display 2428, the input device 2430, the one or more speakers 2492, the one or more microphones 2490, the antenna 2452, and the power supply 2444 may be coupled to a component of the system-in-package or the system-on-chip device 2422, such as an interface or a controller.

The device 2400 may include a smart speaker, a speaker bar, a mobile communication device, a smart phone, a cellular phone, a laptop computer, a computer, a tablet, a personal digital assistant, a display device, a television, a gaming console, a music player, a radio, a digital video player, a digital video disc (DVD) player, a tuner, a camera, a navigation device, a vehicle, a headset, an augmented reality headset, a mixed reality headset, an extended reality headset, a virtual reality headset, an aerial vehicle, a home automation system, a voice-activated device, a wireless speaker and voice activated device, a portable electronic device, a car, a computing device, a communication device, an internet-of-things (IoT) device, a virtual reality (VR) device, a base station, a mobile device, or any combination thereof.

In conjunction with the described implementations, an apparatus includes means for rotating data in a rotation vector register of a rotation vector register file. For example, the means for rotating can correspond to one or more of the rotators 172A-172M, the rotation circuitry 142, the rotation VR file 140, the one or more processors 190, the device 102, the system 100 of FIG. 1A, the processor 2406, the one or more processors 2410, the device 2400, one or more other circuits or components configured to rotate data in a rotation vector register of a rotation vector register file, or any combination thereof.

The apparatus also includes means for receiving first input data at multiply-accumulate circuitry (MAC) from the rotation vector register file. For example, the means for receiving the first input data can correspond to one or more of the inputs 407A-H of the MAC 160, the one or more processors 190, the device 102, the system 100 of FIG. 1A, the processor 2406, the one or more processors 2410, the device 2400, one or more other circuits or components configured to receive input data at the MAC from the rotation vector register file, or any combination thereof.

The apparatus further includes means for receiving second input data at the MAC from a source vector register of a second vector register file. For example, the means for receiving the second input data can correspond to one or more of the inputs 409A-H of the MAC 160, the one or more processors 190, the device 102, the system 100 of FIG. 1A, the processor 2406, the one or more processors 2410, the device 2400, one or more other circuits or components configured to receive input data at the MAC from the source vector register, or any combination thereof.

In some implementations, a non-transitory computer-readable medium (e.g., a computer-readable storage device, such as the memory 2486) includes instructions (e.g., the instructions 2456) that, when executed by one or more processors (e.g., the one or more processors 2410 or the processor 2406), cause the one or more processors to rotate, using a rotation vector register file (e.g., the rotation VR file 140), data in a rotation vector register (e.g., the rotation VR 144A) of the rotation vector register file. The instructions, when executed by the one or more processors, also cause the one or more processors to receive, at multiply-accumulate circuitry (MAC) (e.g., the MAC 160), first input data (e.g., the data 145) from the rotation vector register file. The instructions, when executed by the one or more processors, also cause the one or more processors to receive, at the MAC, second input data (e.g., the data 155) from a source vector register (e.g., the source VR 154) of a second vector register file (e.g., the VR file 150).

Particular aspects of the disclosure are described below in sets of interrelated examples:

According to Example 1, a device includes a processor that includes: a rotation vector register file including: a rotation vector register, the rotation vector register file configured to rotate data in the rotation vector register; a second vector register file including a source vector register; and multiply-accumulate circuitry (MAC) configured to receive first input data from the rotation vector register file and second input data from the source vector register.

Example 2 includes the device of Example 1, wherein the first input data includes a sub-vector value of the rotation vector register, wherein the sub-vector value has multiple elements, and wherein the processor further includes broadcast circuitry configured to, for each element of the multiple elements, provide the element to a respective distinct input of multiple inputs of the MAC.

Example 3 includes the device of Example 1 or Example 2, wherein the second vector register file includes an accumulate vector register, and wherein the MAC is configured to: generate an output based on the first input data and the second input data; and store the output in the accumulate vector register.

Example 4 includes the device of any of Example 1 to Example 3, wherein the first input data includes a first input sub-vector value, wherein the second input data includes a second input sub-vector value, wherein the second vector register file includes an accumulate vector register, and wherein the MAC is configured to: generate a first output sub-vector value based on the first input sub-vector value and the second input sub-vector value; and store the first output sub-vector value in the accumulate vector register.

Example 5 includes the device of Example 4, wherein the MAC is configured to: receive a third input sub-vector value from the source vector register; generate a second output sub-vector value based on the first input sub-vector value and the third input sub-vector value; and store the second output sub-vector value in the accumulate vector register.

Example 6 includes the device of any of Example 1 to Example 5, wherein the rotation vector register file is configured to rotate the data by a rotation amount.

Example 7 includes the device of Example 6, wherein the rotation amount is selectable.

Example 8 includes the device of Example 6 or Example 7, wherein the rotation amount is based on an opcode of a multiply accumulate instruction or a parameter of the multiply accumulate instruction.

Example 9 includes the device of any of Example 6 to Example 8, wherein the rotation vector register file includes rotation circuitry, the rotation circuitry includes: a first rotator coupled to an output of the rotation vector register, the first rotator configured to perform a first data rotation corresponding to a first rotation amount to generate first rotation data; and a second rotator coupled to an output of the first rotator, the second rotator configured to perform a second data rotation corresponding to a second rotation amount to generate second rotation data, wherein an output of the second rotator is coupled to an input of the rotation vector register to update the data in the rotation vector register with the second rotation data.

Example 10 includes the device of Example 9, wherein the second rotation amount is selectable.

Example 11 includes the device of Example 9 or Example 10, wherein the MAC is configured to receive the second rotation data from the rotation vector register as the first input data.

Example 12 includes the device of any of Example 1 to Example 11, wherein the rotation vector register file further includes: a second rotation vector register; and configurable selection circuitry configured to: in a first configuration, output a first sub-vector value from the rotation vector register as the first input data; and in a second configuration, output a second sub-vector value from the rotation vector register and a third sub-vector value from the second rotation vector register as the first input data.

Example 13 includes the device of any of Example 1 to Example 12, wherein the processor is configured to execute a multiply accumulate instruction to: retrieve the first input data from the rotation vector register file; retrieve the second input data from the source vector register; process the first input data and the second input data at the MAC; and rotate the data in the rotation vector register.

Example 14 includes the device of Example 13, wherein the data is rotated in the rotation vector register after the first input data is retrieved from the rotation vector register file.

Example 15 includes the device of any of Example 1 to Example 14, wherein the processor is integrated into at least one of a mobile device, a headset device, a wearable electronic device, a wireless speaker and voice activated device, a camera device, an extended reality headset, or a vehicle.

According to Example 16, a processor-implemented method includes: rotating, using a rotation vector register file, data in a rotation vector register of the rotation vector register file; receiving, at multiply-accumulate circuitry (MAC), first input data from the rotation vector register file; and receiving, at the MAC, second input data from a source vector register of a second vector register file.

Example 17 includes the processor-implemented method of Example 16, wherein the first input data includes a sub-vector value of the rotation vector register, wherein the sub-vector value has multiple elements, and further including, for each element of the multiple elements, providing, using broadcast circuitry, the element to a respective distinct input of multiple inputs of the MAC.

Example 18 includes the processor-implemented method of Example 16 or Example 17, further including: generating, using the MAC, an output based on the first input data and the second input data; and storing the output in an accumulate vector register of the second vector register file.

Example 19 includes the processor-implemented method of any of Example 16 to Example 18, further including: generating, at the MAC, a first output sub-vector value based on a first input sub-vector value and a second input sub-vector value, wherein the first input data includes the first input sub-vector value, and wherein the second input data includes the second input sub-vector value; and storing the first output sub-vector value in an accumulate vector register of the second vector register file.

Example 20 includes the processor-implemented method of Example 19, further including: receiving, at the MAC, a third input sub-vector value from the source vector register; generating, at the MAC, a second output sub-vector value based on the first input sub-vector value and the third input sub-vector value; and storing the second output sub-vector value in the accumulate vector register.

Example 21 includes the processor-implemented method of any of Example 16 to Example 20, wherein the rotation vector register file is used to rotate the data by a rotation amount.

Example 22 includes the processor-implemented method of Example 21, wherein the rotation amount is selectable.

Example 23 includes the processor-implemented method of Example 21 or Example 22, wherein the rotation amount is based on an opcode of a multiply accumulate instruction or a parameter of the multiply accumulate instruction.

Example 24 includes the processor-implemented method of any of Example 21 to Example 23, further including: performing, using a first rotator of rotation circuitry of the rotation vector register file, a first data rotation corresponding to a first rotation amount to generate first rotation data; performing, using a second rotator of the rotation circuitry, a second data rotation corresponding to a second rotation amount to generate second rotation data; and updating the data in the rotation vector register with the second rotation data.

Example 25 includes the processor-implemented method of Example 24, wherein the second rotation amount is selectable.

Example 26 includes the processor-implemented method of Example 24 or Example 25, wherein the second rotation data is received from the rotation vector register at the MAC as the first input data.

Example 27 includes the processor-implemented method of any of Example 16 to Example 26, further including: in a first configuration, outputting a first sub-vector value from the rotation vector register as the first input data; and in a second configuration, outputting a second sub-vector value from the rotation vector register and a third sub-vector value from a second rotation vector register as the first input data, wherein the rotation vector register file includes the second rotation vector register.

Example 28 includes the processor-implemented method of any of Example 16 to Example 27, further including executing a multiply accumulate instruction including: retrieving the first input data from the rotation vector register file; retrieving the second input data from the source vector register; processing the first input data and the second input data at the MAC; and rotating the data in the rotation vector register.

Example 29 includes the processor-implemented method of Example 28, wherein the data is rotated in the rotation vector register after the first input data is retrieved from the rotation vector register file.

Example 30 includes the processor-implemented method of any of Example 16 to Example 29, wherein the rotation vector register file, the MAC, and the second vector register file are integrated into at least one of a mobile device, a headset device, a wearable electronic device, a wireless speaker and voice activated device, a camera device, an extended reality headset, or a vehicle.

According to Example 31, a device includes: a memory configured to store instructions; and a processor configured to execute the instructions to perform the processor-implemented method of any of Example 16 to 30.

According to Example 32, a non-transitory computer-readable medium stores instructions that, when executed by a processor, cause the processor to perform the processor-implemented method of any of Example 16 to Example 30.

According to Example 33, an apparatus includes means for carrying out the processor-implemented method of any of Example 16 to Example 30.

According to Example 34, a non-transitory computer-readable medium stores instructions that, when executed by a processor, cause the processor to: rotate, using a rotation vector register file, data in a rotation vector register of the rotation vector register file; receive, at multiply-accumulate circuitry (MAC), first input data from the rotation vector register file; and receive, at the MAC, second input data from a source vector register of a second vector register file.

Example 35 includes the non-transitory computer-readable medium of Example 34, wherein the first input data includes a sub-vector value of the rotation vector register, wherein the sub-vector value has multiple elements, and wherein the instructions, when executed by the processor, cause the processor to, for each element of the multiple elements, provide, using broadcast circuitry, the element to a respective distinct input of multiple inputs of the MAC.

According to Example 36, an apparatus includes: means for rotating data in a rotation vector register of a rotation vector register file; means for receiving first input data at multiply-accumulate circuitry (MAC) from the rotation vector register file; and means for receiving second input data at the MAC from a source vector register of a second vector register file.

Example 37 includes the apparatus of Example 36, wherein the means for rotating, the means for receiving the first input data, and the means for receiving the second input data are integrated into at least one of a smart speaker, a speaker bar, a computer, a tablet, a display device, a television, a gaming console, a music player, a radio, a digital video player, a camera, a navigation device, a vehicle, a headset, an augmented reality headset, a mixed reality headset, a virtual reality headset, an extended reality headset, an aerial vehicle, a home automation system, a voice-activated device, a wireless speaker and voice activated device, a portable electronic device, a communication device, an internet-of-things (IoT) device, a virtual reality (VR) device, a base station, or a mobile device.

Those of skill would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, such implementation decisions are not to be interpreted as causing a departure from the scope of the present disclosure.

The steps of a method or algorithm described in connection with the implementations disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. A device comprising a processor that includes:
a rotation vector register file comprising a rotation vector register, the rotation vector register file configured to rotate data in the rotation vector register;
a second vector register file including a source vector register; and
multiply-accumulate circuitry (MAC) configured to receive first input data from the rotation vector register file and second input data from the source vector register.

2. The device of claim 1, wherein the first input data includes a sub-vector value of the rotation vector register, wherein the sub-vector value has multiple elements, and wherein the processor further comprises broadcast circuitry configured to, for each element of the multiple elements, provide the element to a respective distinct input of multiple inputs of the MAC.

3. The device of claim 1, wherein the second vector register file includes an accumulate vector register, and wherein the MAC is configured to:
generate an output based on the first input data and the second input data; and
store the output in the accumulate vector register.

4. The device of claim 1, wherein the first input data includes a first input sub-vector value, wherein the second input data includes a second input sub-vector value, wherein the second vector register file includes an accumulate vector register, and wherein the MAC is configured to:
generate a first output sub-vector value based on the first input sub-vector value and the second input sub-vector value; and
store the first output sub-vector value in the accumulate vector register.

5. The device of claim 4, wherein the MAC is configured to:
receive a third input sub-vector value from the source vector register;
generate a second output sub-vector value based on the first input sub-vector value and the third input sub-vector value; and
store the second output sub-vector value in the accumulate vector register.

6. The device of claim 1, wherein the rotation vector register file is configured to rotate the data by a rotation amount.

7. The device of claim 6, wherein the rotation amount is selectable.

8. The device of claim 6, wherein the rotation amount is based on an opcode of a multiply accumulate instruction or a parameter of the multiply accumulate instruction.

9. The device of claim 6, wherein the rotation vector register file further includes rotation circuitry, the rotation circuitry comprises:
a first rotator coupled to an output of the rotation vector register, the first rotator configured to perform a first data rotation corresponding to a first rotation amount to generate first rotation data; and
a second rotator coupled to an output of the first rotator, the second rotator configured to perform a second data rotation corresponding to a second rotation amount to generate second rotation data,
wherein an output of the second rotator is coupled to an input of the rotation vector register to update the data in the rotation vector register with the second rotation data.

10. The device of claim 9, wherein the second rotation amount is selectable.

11. The device of claim 9, wherein the MAC is configured to receive the second rotation data from the rotation vector register as the first input data.

12. The device of claim 1, wherein the rotation vector register file further includes:
a second rotation vector register; and
configurable selection circuitry configured to:
in a first configuration, output a first sub-vector value from the rotation vector register as the first input data; and
in a second configuration, output a second sub-vector value from the rotation vector register and a third sub-vector value from the second rotation vector register as the first input data.

13. The device of claim 1, wherein the processor is configured to execute a multiply accumulate instruction to:
retrieve the first input data from the rotation vector register file;
retrieve the second input data from the source vector register;
process the first input data and the second input data at the MAC; and
rotate the data in the rotation vector register.

14. The device of claim 13, wherein the data is rotated in the rotation vector register after the first input data is retrieved from the rotation vector register file.

15. The device of claim 1, wherein the processor is integrated into at least one of a mobile device, a headset device, a wearable electronic device, a wireless speaker and voice activated device, a camera device, an extended reality headset, or a vehicle.

16. A processor-implemented method comprising:
rotating, using a rotation vector register file, data in a rotation vector register of the rotation vector register file;
receiving, at multiply-accumulate circuitry (MAC), first input data from the rotation vector register file; and
receiving, at the MAC, second input data from a source vector register of a second vector register file.

17. The processor-implemented method of claim 16, wherein the first input data includes a sub-vector value of the rotation vector register, wherein the sub-vector value has multiple elements, and further comprising, for each element of the multiple elements, providing, using broadcast circuitry, the element to a respective distinct input of multiple inputs of the MAC.

18. The processor-implemented method of claim 16, further comprising:
generating, using the MAC, an output based on the first input data and the second input data; and
storing the output in an accumulate vector register of the second vector register file.

19. The processor-implemented method of claim 16, further comprising:
generating, at the MAC, a first output sub-vector value based on a first input sub-vector value and a second input sub-vector value, wherein the first input data includes the first input sub-vector value, and wherein the second input data includes the second input sub-vector value; and
storing the first output sub-vector value in an accumulate vector register of the second vector register file.

20. The processor-implemented method of claim 19, further comprising:
receiving, at the MAC, a third input sub-vector value from the source vector register;
generating, at the MAC, a second output sub-vector value based on the first input sub-vector value and the third input sub-vector value; and
storing the second output sub-vector value in the accumulate vector register.

21. The processor-implemented method of claim 16, wherein the rotation vector register file is used to rotate the data by a rotation amount.

22. The processor-implemented method of claim 21, wherein the rotation amount is selectable.

23. The processor-implemented method of claim 21, wherein the rotation amount is based on an opcode of a multiply accumulate instruction or a parameter of the multiply accumulate instruction.

24. The processor-implemented method of claim 21, further comprising:
performing, using a first rotator of rotation circuitry of the rotation vector register file, a first data rotation corresponding to a first rotation amount to generate first rotation data;
performing, using a second rotator of the rotation circuitry, a second data rotation corresponding to a second rotation amount to generate second rotation data; and
updating the data in the rotation vector register with the second rotation data.

25. The processor-implemented method of claim 24, wherein the second rotation amount is selectable.

26. The processor-implemented method of claim 16, further comprising executing a multiply accumulate instruction including:
retrieving the first input data from the rotation vector register file;
retrieving the second input data from the source vector register;
processing the first input data and the second input data at the MAC; and
rotating the data in the rotation vector register.

27. A non-transitory computer-readable medium storing instructions that, when executed by a processor, cause the processor to:
rotate, using a rotation vector register file, data in a rotation vector register of the rotation vector register file;
receive, at multiply-accumulate circuitry (MAC), first input data from the rotation vector register file; and
receive, at the MAC, second input data from a source vector register of a second vector register file.

28. The non-transitory computer-readable medium of claim 27, wherein the first input data includes a sub-vector value of the rotation vector register, wherein the sub-vector value has multiple elements, and wherein the instructions, when executed by the processor, cause the processor to, for each element of the multiple elements, provide, using broadcast circuitry, the element to a respective distinct input of multiple inputs of the MAC.

29. An apparatus comprising:
means for rotating data in a rotation vector register of a rotation vector register file;
means for receiving first input data at multiply-accumulate circuitry (MAC) from the rotation vector register file; and
means for receiving second input data at the MAC from a source vector register of a second vector register file.

30. The apparatus of claim 29, wherein the means for rotating, the means for receiving the first input data, and the means for receiving the second input data are integrated into at least one of a smart speaker, a speaker bar, a computer, a tablet, a display device, a television, a gaming console, a music player, a radio, a digital video player, a camera, a navigation device, a vehicle, a headset, an augmented reality headset, a mixed reality headset, a virtual reality headset, an aerial vehicle, a home automation system, a voice-activated device, a wireless speaker and voice activated device, a portable electronic device, a communication device, an internet-of-things (IoT) device, a virtual reality (VR) device, a base station, or a mobile device.
